(19) United States
(12) Patent Application Publication
(10) Pub. No.: US 2026/0127526 A1
(43) Pub. Date: May 7, 2026

(54) SYSTEMS AND METHODS FOR ANALYZING AND MITIGATING COMMUNITY-ASSOCIATED RISKS

(71) Applicant: State Farm Mutual Automobile Insurance Company, Bloomington, IL (US)

(72) Inventors: Matthew Megyese, Phoenix, AZ (US); Sarah Ann Lockenvitz, Scottsdale, AZ (US); Paul Bates, Mesa, AZ (US); Nicholas Carmelo Marotta, Scottsdale, AZ (US); Cathy Jo Roth, Queen Creek, AZ (US); Austin Rowley, Mesa, AZ (US); Jared Wheet, Mesa, AZ (US)

(21) Appl. No.: 17/018,815

(22) Filed: Sep. 11, 2020

Related U.S. Application Data
(60) Provisional application No. 62/945,630, filed on Dec. 9, 2019.

(51) Int. Cl. G06Q 10/0635; G06N 20/00; G06Q 40/08

(52) U.S. Cl. CPC G06Q 10/0635; G06N 20/00; G06Q 40/08

(57) ABSTRACT

A computer system for analyzing and mitigating risks associated with an event is provided. The computer system is configured to: (i) receive at least one of a city risk profile and a building risk profile from a database; (ii) receive city systems data from the city services computer system; (iii) utilize a trained machine learning model to determine at least one potential risk associated with the event; (iv) generate an event risk profile that includes the at least one potential risk associated with the event; and/or (v) generate a risk mitigation output based upon at least one of the city risk profile and the at least one potential risk, wherein the risk mitigation output includes at least one of a risk alert, a risk mitigation recommendation, and risk mitigation instructions. Computer systems for analyzing and mitigation risks associated with a city, a building, and a user are also provided.

### CROSS-REFERENCE TO RELATED APPLICATIONS

This application claims priority to U.S. Provisional Patent Application Ser. No. 62/945,630, filed Dec. 9, 2019, entitled “SYSTEMS AND METHODS FOR ANALYZING AND MITIGATING COMMUNITY-ASSOCIATED RISKS,” the entire contents and disclosure of which are hereby incorporated herein by reference in their entirety.

### FIELD OF THE INVENTION

The present disclosure relates to “smart cities” and, more particularly, to analyzing data in order to determine and mitigate risks associated with communities or gatherings of people, including cities, municipalities, towns, and/or events.

### BACKGROUND

More than ever, information and communications technologies are being applied to new industries in order to improve efficiencies, analyze impact of projects, and mitigate risks. “Smart cities” may utilize information and communications technologies at a city-wide level to achieve these outcomes. Mitigating risk may be of particular concern for modern cities as infrastructure becomes ever-more complex, expensive, and technologically advanced. Risk factors within a city may include risks associated with individual buildings, the layout of the city itself, criminal activity within the city, construction, traffic, man-made events, and natural disasters, among others.

As governments, companies, and individuals become more aware of potential safety and economic risks, and in some cases become more risk averse, reducing risk becomes even more desirable. Further, as more complex technologies are implemented throughout cities and the amount of available data continues to grow, managing this data in an efficient, useful way to achieve particular outcomes is increasingly important. Conventional techniques of city management and organization may have other drawbacks as well.

### BRIEF SUMMARY

The present embodiments may relate to systems and methods for analyzing and mitigating city-related risks. The system may include one or more user computing devices, one or more environmental sensors, one or more third party computer systems, one or more insurance provider servers, and/or one or more databases. The computer systems and computer-implemented methods may enable effective organization and utilization of collected data in order to mitigate city-related risks.

In one aspect, a computer system for analyzing and mitigating risks associated with an event may be provided. The computer system may include at least one processor and/or associated transceiver in communication with at least one memory device, at least one sensor, at least one third party computer device, at least one city services computer system including a controller, and at least one database. The at least one processor may be programmed to: (i) receive at least one of a city risk profile and a building risk profile from the at least one database; (ii) receive city systems data from the city services computer device; (iii) utilize a trained machine learning model to determine at least one potential risk associated with the event based upon the city systems data and at least one of the city risk profile and the building risk profile; (iv) generate an event risk profile that includes the at least one potential risk associated with the event; and/or (v) generate a risk mitigation output based upon at least one of the event risk profile and the at least one potential risk, wherein the risk mitigation output includes at least one of a risk alert, a risk mitigation recommendation, and risk mitigation instructions. The computer system may include additional, less, or alternate functionality, including that discussed elsewhere herein.

In another aspect, a computer-implemented method for analyzing and mitigating risks associated with an event may be provided. The method may be implemented by a computer system including at least one processor and/or associated transceiver in communication with at least one memory device, at least one city services computer system including a controller, and at least one database. The method may include, via one or more processors and/or associated transceivers: (i) receiving at least one of a city risk profile and a building risk profile from the at least one database; (ii) receiving city systems data from the city services computer device; (iii) utilizing a trained machine learning model to determine at least one potential risk associated with the event based upon the city systems data and at least one of the city risk profile and the building risk profile; (iv) generating an event risk profile that includes the at least one potential risk associated with the event; and/or (v) generating a risk mitigation output based upon at least one of the event risk profile and the at least one potential risk, wherein the risk mitigation output includes at least one of a risk alert, a risk mitigation recommendation, and risk mitigation instructions. The computer-implemented method may include additional, less, or alternate actions, including those discussed elsewhere herein.

In another aspect, a non-transitory computer-readable storage medium having computer-executable instructions embodied thereon for analyzing and mitigating risks associated with an event may be provided. When executed by at least one processor, the computer-executable instructions may cause the processor to: (i) receive at least one of a city risk profile and a building risk profile from the at least one database; (ii) receive city systems data from the city services computer device; (iii) utilize a trained machine learning model to determine at least one potential risk associated with the event based upon the city systems data and at least one of the city risk profile and the building risk profile; (iv) generate an event risk profile that includes the at least one potential risk associated with the event; and/or (v) generate a risk mitigation output based upon at least one of the event risk profile and the at least one potential risk, wherein the risk mitigation output includes at least one of a risk alert, a risk mitigation recommendation, and risk mitigation instructions. The computer-executable instructions may direct additional, less, or alternate functionality, including that discussed elsewhere herein.

Advantages will become more apparent to those skilled in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates a block diagram of an exemplary city risk mitigation (“CRM”) computer system for analyzing and mitigating risk associated with a city.

FIG. 2 illustrates an exemplary data flow using a building-risk embodiment of the CRM computer system described in FIG. 1.

FIG. 3 illustrates an exemplary data flow using a city-risk embodiment of the CRM computer system described in FIG. 1.

FIG. 4 illustrates an exemplary data flow using a user-risk embodiment of the CRM computer system described in FIG. 1.

FIG. 5 illustrates an exemplary data flow using an event-risk embodiment of the CRM computer system described in FIG. 1.

FIG. 6 illustrates a data flow using exemplary modules utilized by a city risk mitigation (“CRM”) computer device, which may be a component of the CRM computer system described in FIG. 1.

FIG. 7 illustrates a schematic diagram of an exemplary user computing device that may be including in the CRM computer system described in FIG. 1.

FIG. 8 illustrates a schematic diagram of an exemplary server computing device that may be included in the CRM computer system described in FIG. 1.

FIG. 9 illustrates a diagram of an exemplary computer device and internal components, which may be similar to the CRM computing device described in FIG. 1.

FIGS. 10-13 each illustrate an exemplary flow chart of a method for analyzing and mitigating city-associated risk using a CRM computer system as described in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer systems and computer-implemented methods for analyzing and mitigating city-associated risks. In particular, the systems and methods include a city risk mitigation (“CRM”) computer system configured to detect potential risks associated with a city and generate risk-mitigating outputs such as risk alerts and risk mitigation recommendations. In the exemplary embodiment, the CRM computer system may include a city risk mitigation (“CRM”) computer device configured to receive data from multiple sources throughout a city and analyze the data to identify potential risks associated with the city. The CRM computing device may be further configured to generate risk profiles for different aspects of the city based upon identified risks and to generate outputs for mitigating the identified risks.

Although the term “city” or “cities” is used herein, the disclosure is not limited specifically to cities. Rather, the embodiments and functionalities described herein may apply to any community, municipality, township, county, state, province, region, country, nation-state, or any other grouping or gathering of people and/or infrastructure. Additionally, the embodiments and functionalities described herein may apply to any “smart” infrastructure, internet of things (IOT), and/or information and communications (IOC) application.

In the exemplary embodiment, the CRM computing device may be configured to receive data from various sources throughout a city (e.g., environmental sensors, city services computer systems, and user computer devices), analyze the city-related data (e.g., data related to buildings, city services, the environment, and users), generate risk profiles for different aspects of the city (e.g., building risk profiles, city risk profiles, user risk profiles, and event risk profiles), and generate risk mitigation outputs that may alert users, provide suggested courses of action, and/or automatically cause computer systems to take risk mitigating actions.

In an exemplary embodiment, the CRM computer system may include environmental sensors, a third party computer system, an admin computer device, a user computer device, an insurance provider computer device, and a database that may all be in communication with the CRM computing device. In alternative embodiments, the CRM computer system may include the CRM computing device in communication with any number of the aforementioned components in any combination.

### Exemplary Methods for Analyzing and Mitigating City-Related Risks

In the exemplary embodiment, the CRM computing device may be configured to identify potential risks across multiple aspects of a city. In one embodiment, the CRM computing device may identify risks associated with a specific building. For example, the CRM computing device may analyze a building's layout, materials used in construction, and a current sprinkler system to determine that a building is at a particularly high risk of fire damage.

In another embodiment, the CRM computing device may identify risks associated with a city or a portion of a city. For example, the CRM computing device may aggregate risks associated with individual buildings and further analyze a city's layout to determine areas of the city that may be at particularly high risk of fire damage.

In another embodiment, the CRM computing device may identify risks associated with an individual user or group of users. For example, the CRM computing device may analyze a user's daily commute along with a city risk profile and determine that the user travels through multiple areas with high potential for automobile accidents.

In yet another embodiment, the CRM computing device may identify risks associated with an event. For example, the CRM computing device may analyze traffic data and weather data to determine that an ice storm is incoming and that the storm has a particularly high risk of damage given the number of cars on the roads.

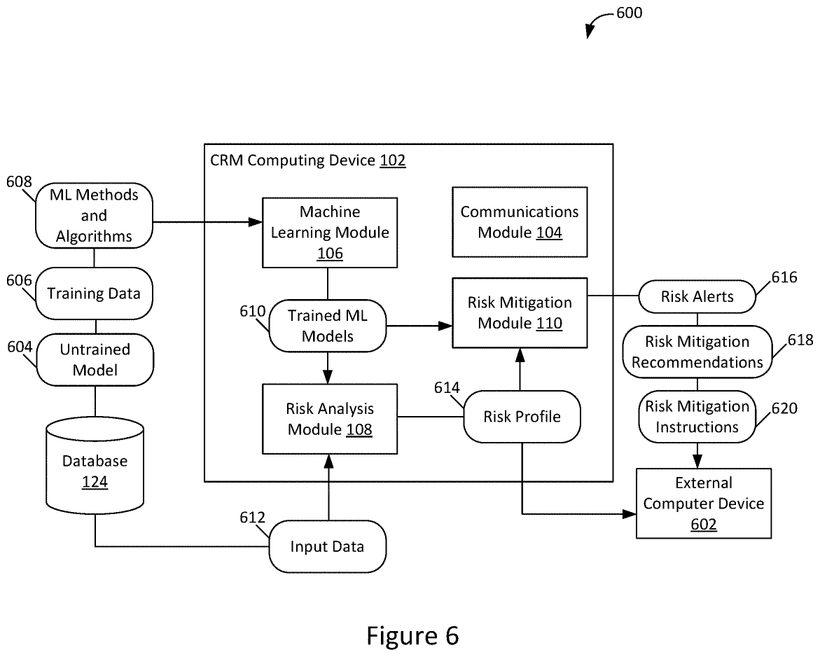

In the exemplary embodiment, the CRM computing device may be configured to receive data from various sources, analyze the data, recognize patterns, predict future outcomes, and identify potential risks. In one embodiment, the CRM computing device may utilize a trained machine learning (“ML”) model to analyze the data and identify potential risks. The ML model may be trained by processing historical city-related data using any appropriate machine learning techniques and algorithms (described in more detail with regard to FIG. 6 below).

In one embodiment, the CRM computing device may be configured to analyze received data types individually or in combination. For example, the CRM computing device may receive weather data and traffic data and determine patterns in the weather data and traffic data separately. As another example, the CRM computing device may receive weather data and traffic data and determine a relationship between weather data and traffic data. The CRM computing device may be further configured to identify potential risks indicated by received data.

The CRM computing device may identify potential risks indicated by a single data type or multiple data types in combination. For example, the CRM computing device may receive data from a pressure sensor indicating a steep drop in atmospheric pressure and determine a storm is on the way that may pose a risk to the city. As another example, the CRM computing device may receive data from a pressure sensor indicating a steep drop in pressure and a weather report indicating an approaching storm, and the CRM computing device may determine with greater certainty that a storm is approaching the city.

In one embodiment, the CRM computing device may be configured to identify potential risks by determining a risk score associated with various potential outcomes. In other words, the CRM computing device may receive various data points, determine potential outcomes indicated by the data points, and determine a risk-score for all the potential outcomes. In one embodiment, the CRM computing device may determine risk-scores for multiple aspects of a potential risk, and may determine an aggregate risk score based upon the aspect risk scores.

Specifically, the CRM computing device may identify potential outcomes, score the “likelihood” of each outcome, along with the “severity of damage” of each outcome, and determine an overall risk-score taking into account both the likelihood score and the severity of damage score. For example, the CRM computing device may receive building data including a building's layout, security system data including the layout of the building's security system, and sensor data including human activity outside the building at different times of day. The CRM computing device may determine a likelihood of a break-in for every hour of the day based upon the human activity, building layout, and security system. Further, the CRM computing device may determine the severity of potential damage based upon how adequately the security system may mitigate the effects of a break-in. In alternative embodiments, the CRM computing device may identify and scores aspects of potential risks including but not limited to: likelihood of an event, likelihood of damage, potential economic impact, ability to mitigate the risk, importance of the risk, timeframe of the risk, and other aspects of predicted outcomes that may relate to potential risk associated with the outcome.

In one embodiment, the CRM computing device flags potential risks with a risk-score that meets a certain threshold. In an alternative embodiment, the CRM computing device flags potential risks for which at least one aspect of risk meets a threshold. For example, the CRM computing device may flag all potential risks that have a risk-score over some numeric value.

In another embodiment, the CRM computing device gives a qualitative rating to risks based upon risk-scored. For example, the CRM computing device may score outcomes as “high”, “medium”, or “low” risk.

In the exemplary embodiment, the CRM computing device may be configured to generate a risk profile associated with some aspect of a city (e.g., a building risk profile, a city risk profile, a user risk profile, and/or an event risk profile). In one embodiment, the CRM computing device may generate a risk profile based upon predicted outcomes and potential risk as described above. In one embodiment, the CRM computing device may generate a risk profile that specifies a level of risk for a particular building, city, user, or event over a period of time.

In other words, the risk profile may include likelihood or severity of potential risks at given times. For example, the CRM computing device may generate an event risk profile for a severe weather event that includes potential damages incurred by the weather event at each hour of the day. In another embodiment, the CRM computing device may generate a risk profile for a building, city, user, or event that takes additional risk profiles into account. For example, a city risk profile may include an aggregate of individual building risk profiles aggregated using a city layout.

In one embodiment, a risk profile includes a computer-generated visualization of risk, which may be a 2D representation or a 3D model. For example, a city risk profile may include a heat map of the city, with riskier (e.g., more dangerous) areas of the city visualized as a hotter color, while less risky areas of the city are visualized as a colder color. Similarly, specific buildings may be hotter or colder depending on individual building risk profiles. The heat map may be in the form of a 2D or 3D city model. In the exemplary embodiment, CRM computing device may generate a risk profile using any of the risk determination techniques, risk scoring methods, or risk visualization methods described herein.

In the exemplary embodiment, the CRM computing device may be configured to generate risk mitigation outputs based upon the risk profile. As used herein, risk mitigation outputs refer to at least risk alerts, risk mitigation recommendations, and risk mitigation instructions. In general, risk alerts refer to alerts, notifications, messages, emails, status updates, etc. that are transmitted to a user computer device or any other external computer device for bringing a user's attention to some risk that was identified by the CRM computing device.

Risk mitigation recommendations refer to any email, message, report, attached document, status update, notification, etc. that includes suggested, risk-mitigating actions that may be implemented by a user or a computer system. Risk mitigation instructions refer to computer-executable instructions for automatically implementing some risk-mitigating action using a computer system or a physical system linked to a controller.

In some embodiments, the CRM computing device may store and/or add risk mitigation outputs to risk profiles. In other embodiments, the CRM computing device may update risk profiles with the generated risk mitigation outputs. Risk alerts, risk mitigation recommendations, and risk mitigation instructions are described in more detail below.

### Exemplary Embodiments Describing the Generation and Utilization of Risk Profiles

In one embodiment, the CRM computing device may be configured to generate a building risk profile detailing potential risks for a building or group of buildings. The CRM computing device may be configured to receive environment data (e.g., external environment data such as weather data and internal environment data such as internal building temperature data) from environmental sensors, building systems data (e.g., status of a security system or sprinkler system) from a building management computer system, and building data (e.g., building floor plans, materials used in construction, or a 3D model of the building) from a database. The CRM computing device may be configured to analyze the received data, determine potential risks, and generate a building risk profile detailing the potential risks and any associated risk scores. Based upon the data and the building risk profile, the CRM computing device may be further configured to generate risk mitigation outputs, including risk alerts, risk mitigation recommendations, and risk mitigation instructions. The CRM computing device may be configured to transmit the risk alerts and risk mitigation recommendations to any of a user computer device, admin computer device, and insurance provider computer device. Additionally, the CRM computing device may be configured to transmit the risk mitigation instructions to the building management computer system for implementation.

For example, the CRM computing device may receive building data describing the materials used in the construction of a building and the age of the building and may further receive internal and external environment data describing the internal temperature and humidity conditions and the external weather conditions the building was subject to over a number of years. The CRM computing device may analyze the type and age of materials along with the weather conditions and determine whether the building may present a safety risk due to failing materials. The CRM computing device may generate a risk profile for the building based upon the analysis, and further generate a recommendation to reinforce or renovate certain areas of the building, or in some cases, to condemn the building if the risk is above a certain threshold.

In another embodiment, the CRM computing device may be configured to generate a city risk profile for a city or portion of a city and generate risk mitigation outputs for the city. The CRM computing device may be configured to receive environment data (e.g., external environment data such as weather) from environmental sensors, city systems data (e.g., state of traffic signals, capacity and range of emergency vehicles, and dispersion of police forces) from a city services computer system, and both city data (e.g., city layouts and 3D models) and at least one building risk profile from a database. The CRM computing device may be configured to analyze the received data and generate a city risk profile for the city or portion of the city. Based upon the data and the city risk profile, the CRM computing device may be further configured to generate a risk mitigation recommendation and a risk alert. Additionally, the CRM computing device may be configured to generate risk mitigation instructions and transmit the instructions to the city services computer system for implementation.

For example, the CRM computing device may receive city data including a 3D model of a portion of a city from a database. The CRM computing device may further receive, from a city services computer device, city systems data indicating the status, usage, and layout of city security systems and law enforcement personnel. The CRM computing device may analyze the data and determine the effectiveness and/or certain limitations of the city's security systems in certain areas, and generate a city risk profile based upon the analysis. The CRM computing device may further generate recommendations for improving the city's security systems (e.g., adding new cameras or motion sensors to certain areas) and transmit the recommendations to an admin computer device. The CRM computing device may also generate and transmit computer-readable instructions to the city services computer device that cause the city services computer device to alter the usage of its currently operating cameras and motion sensors, as well as alter routes patrolled by police personnel.

In another embodiment, the CRM computing device may be configured to generate a user risk profile for an individual user or group of users and generate risk mitigation outputs for the user and/or an insurance provider computer device. The CRM computing device may be configured to receive user profile data (e.g., user demographic information and other personal information), a city risk profile, and at least one building risk profile from a database and further receive user activity data (e.g., user location and mode of transportation) from a user computer device. The CRM computing device may be configured to analyze the received data and generate a user risk profile for the individual user or group of users. Based upon the data and the user risk profile, the CRM computing device may be further configured to generate a risk mitigation recommendation and a risk alert. Additionally, the CRM computing device may be configured to generate risk mitigation instructions and transmit the instructions to at least one of the user computer device and insurance provider computer device for implementation.

For example, the CRM computing device may receive a city risk profile indicating streets that are particularly dangerous due to high traffic at certain times of day and user activity data indicating that a user's daily commute includes biking a certain route. The CRM computing device may analyze the data, determine risks associated with the user's biking route, and generate a user risk profile detailing the potential risks. The CRM computing device may further generate and transmit a risk alert and a risk mitigation recommendation to the user computer device. The risk mitigation recommendation may include recommended alternative routes or means of transportation.

In another embodiment, the CRM computing device may be configured to generate an event risk profile for an event (e.g., a man-made event or natural disaster) and generate risk mitigation outputs related to the event. The CRM computing device may be configured to receive environment data (e.g., external environment data such as weather) from environmental sensors, both city systems data (e.g., state of traffic signals, capacity and range of emergency vehicles, and dispersion of police forces) and event data (e.g., incoming natural disaster reports, man-made disturbance reports, or traffic data) from a city services computer system, and both a city risk profile and a building risk profile from a database. The CRM computing device may be configured to analyze the received data and generate an event risk profile related to the event. Based upon the data and the event risk profile, the CRM computing device may be further configured to generate a risk mitigation recommendation and a risk alert, and risk mitigation instructions. The CRM computing device may be configured to transmit at least one of the risk mitigation notification and the risk mitigation instructions to at least one of the city services computer system, user computer device, admin computer device, and insurance provider computer device.

For example, the CRM computing device may receive environment data indicating flooding in a certain area of the city, along with event data including reports of the flood along with potentially affected areas. The CRM computing device may further receive city risk profile data indicating areas of the city that are particularly dangerous during flooding, along with city systems data indicating the status of traffic signals across the city. The CRM computing device may analyze the data, determine risks associated with driving through flooded areas of the city, and detail the potential risks in an event risk profile. The CRM computing device may further generate and transmit risk alerts and risk recommendations advising drivers to avoid flooded areas. Additionally, the CRM computing device may generate risk mitigation instructions that alter the operations of the city's traffic light systems and electronic road sign systems, such that traffic is routed away from potentially dangerous areas.

Technical problems addressed by the CRM computer system include, but are not limited to: (i) inability to organize and utilize a vast amount of data associated with cities communities, or other groups of people; (ii) inability to identify and utilize relationships between various types of data associated with cities, communities, or other groups of people; (iii) inability to systematically identify potential risks associated with a city, community, or other group of people; (iv) inability to systematically quantify and document potential risks associated with a city, community, or other group of people; and (v) inability to utilize identified risks to implement risk mitigating actions.

The methods and systems described herein may be implemented using computer programming or engineering techniques including computer software, firmware, hardware, or any combination thereof, where the technical effect may be achieved by performing at least one of the following actions: (a) receiving environment data from at least one sensor; (ii) receiving at least one of building data, city data, a building risk profile, a city risk profile, user activity data, event data, and user profile data from at least one database; (iii) receiving at least one of building systems data from a building management computer system, city systems data from a city services computer system, and user activity data from a user computer device; (iv) utilizing a trained machine learning model to determine at least one potential risk associated with a building, city, user, or event based upon at least one of the data types described above; (iv) generating at least one of a building risk profile, city risk profile, user risk profile, and event risk profile that includes the at least one potential risk associated with the building, city, user, or event; and/or (v) generating a risk mitigation output based upon at least one of the building risk profile, city risk profile, user risk profile, event risk profile, and the at least one potential risk, wherein the risk mitigation output includes at least one of a risk alert, a risk mitigation recommendation, and risk mitigation instructions.

Technical solutions addressed by the CRM computer system include, but are not limited to: (i) enabling the organization and utilization of previously underutilized data; (ii) enabling the identification of relationships between various types of data associated with cities, communities, or other groups of people; (iii) enabling the systematic identification of potential risks associated with a city, community, or other group of people; (iv) enabling systematic quantification and documentation of potential risks associated with a city, community, or other group of people; (v) enabling utilization of identified risks to implement risk mitigating actions; (vi) enabling identification of important, useful information from high amounts of noisy data; and/or (vii) reducing bottlenecks in emergency response systems by providing pointed risk mitigation recommendations and risk mitigation instructions.

### Exemplary System for Analyzing and Mitigating City-Related Risk

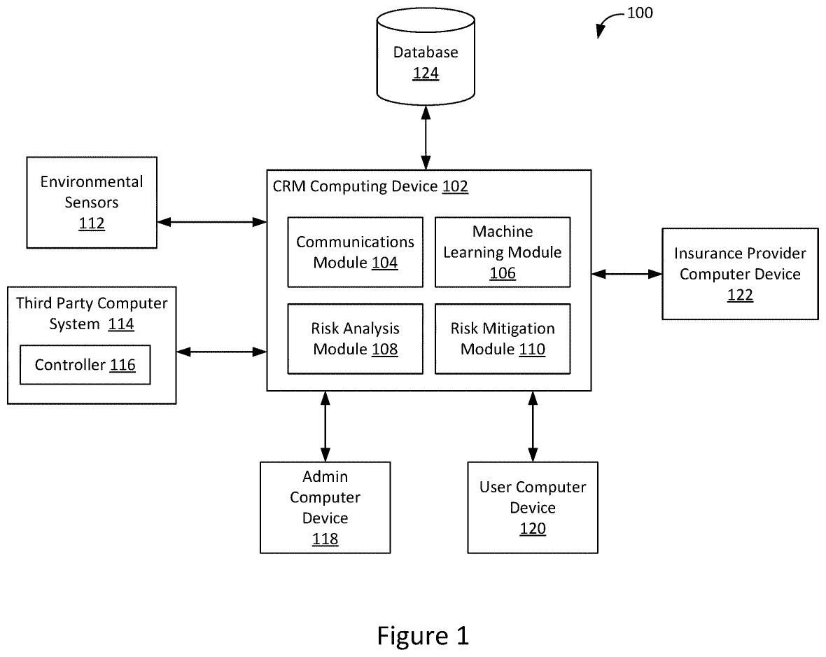

FIG. 1 is a block diagram illustrating an exemplary city risk mitigation (“CRM”) computer system 100. In the exemplary embodiment, CRM computer system 100 may include a city risk mitigation (“CRM”) computer device 102, which may include a communications module 104, a machine learning (“ML”) module 106, a risk analysis module 108, and a risk mitigation module 110. CRM computing device 102 may be communicably coupled to a plurality of environmental sensors 112, at least one third party computer system 114 that includes controller 116, an admin computer device 118, a user computer device 120, an insurance provider computer device 122, and at least one database 124.

In alternative embodiments, CRM computer system 100 may include CRM computing device 102 in communication with any number of the aforementioned components in any combination. For example, CRM computing device 102 may be in communication with a plurality of user computer devices similar to user computer device 120 and a plurality of environmental sensors similar to environmental sensors 112.

CRM computing device 102 may include modules that enable a variety of functionalities. In the exemplary embodiment, CRM computing device 102 may include communications module 104, ML module 106, risk analysis module 108, and risk mitigation module 110. Communications module 104 enables communication between CRM computing device 102 and any remote computer device, such as environmental sensors 112, third party computer system 114, admin computer device 118, user computer device 120, insurance provider computer device 122, and database 124. Additionally, in some embodiments, communications module 104 enables communication between the modules of CRM computing device 102. In some embodiments, CRM computing device 102 may be configured to communicate with external computer devices without a specific communications module.

ML module 106 enables CRM computing device 102 to utilize machine learning capabilities. In some embodiments, ML module 106 is responsible for training machine learning models, such as a risk analysis model or a risk mitigation model. Specifically, ML module 106 may be configured to process large amounts of data, known as training data, in order to develop a trained model capable of making predictions and generating outputs based upon novel input data. In alternative embodiments, ML module 106 may utilize machine learning techniques and algorithms including supervised learning, unsupervised learning, reinforcement learning, or any combination thereof. Machine learning techniques and algorithms that may be employed by ML module 106 are described in further detail in FIG. 6 below.

Risk analysis module 108 may be configured to analyze various data inputs, determine risks indicated in the data, and generate risk profiles for entities or events. Specifically, risk analysis module 108 may be configured to generate at least building risk profiles, city risk profiles, user risk profiles, and event risk profiles based upon data received from environmental sensors 112, third party computer system 114, user computer device 120, and database 124. Risk mitigation module 110 may be configured to utilize risk profiles from risk analysis module 108, along with various data inputs, to generate risk mitigation outputs. Specifically, risk mitigation module 110 may be configured to generate risk alerts, risk mitigation recommendations, and risk mitigation instructions using data from the components mentioned above. Both risk analysis module 108 and risk mitigation module 110 may utilize trained machine learning models to perform their respective functions. Outputs from risk analysis module 108 and risk mitigation module 110 may be transmitted to any of the aforementioned components of CRM computer system 100, via communications module 104 or otherwise.

In the exemplary embodiment, CRM computing device 102 may be configured to receive any data collected by environmental sensors 112. Environmental sensors 112 may be any sensors capable of collecting information about an environment. In the exemplary embodiment, environmental sensors 112 may include sensors placed within or outside of buildings, such that data may be collected related to building interiors as well as the outside environment at a number of different locations. For example, environmental sensors 112 may include, but are not limited to, thermometers, barometers, humidity sensors, precipitation sensors, standing water sensors, radar, SONAR, or Lidar systems, cameras, microphones, stress gauges, image recognition software, motion detectors, light sensors, clocks, timers, smoke and or fire detectors, vibrations sensors, earthquake sensors, radiation sensors, and any other sensors for detecting some aspect of the environment. In some embodiments, environmental sensors 112 include systems for testing the strength and/or wear on certain materials.

In the exemplary embodiment, CRM computing device 102 may be configured to receive systems data and transmit instructions to third party computer system 114. Third party computer system 114 may include controller 116, such that instructions transmitted from CRM computing device 102 to third party computer system 114 may cause controller 116 to implement some change in a physical or digital system.

Third party computer system 114 may include a network of computer devices. For example, third party computer system 114 may be a building security system, a building sprinkler system, an emergency services deployment system, a law enforcement tracking and deployment system, a disaster response system, an evacuation system, or any other system not directly incorporated in CRM computing device 102.

In the exemplary embodiment, CRM computing device 102 may be configured to receive data and instructions from admin computer device 118 and transmit data, such as risk profiles, risk mitigation recommendations, and risk alerts to admin computer device 118. Admin computer device 118 may be any computer device in communication with CRM computing device 102 that allows a user to access and manage aspects of CRM computing device 102. For example, CRM computing device 102 may receive instructions from admin computer device 118 instructing CRM computing device 102 to analyze risk for a particular building, city, individual, or event. Additionally, admin computer device 118 may enable a user to receive and view a risk profile generated by CRM computing device 102. In one embodiment, CRM computer device 102 may be further configured to receive user preferences, settings inputs, or other operations inputs from admin computer device 118.

In the exemplary embodiment, CRM computing device may be in communication with user computer device 120. User computer device 120 may be a computer device associated with an individual user or group of users and may include, but is not limited to, a mobile computing device, a smart phone, a desktop a laptop, a tablet, or any other type of computer device accessible by an individual. User computer device 120 may include GPS or some other location tracking technology, and CRM computing device 102 may receive user activity data from a user computer device, including a user's location. CRM computing device may be configured to transmit risk mitigation recommendations, risk alerts, and risk mitigation instructions to user computer device 120, such that a user might be alerted about an identified risk or presented with recommendations for reducing risky activities.

In the exemplary embodiment, CRM computing device 102 may be configured to receive data from insurance provider computer device 122 and transmit data, such as risk profiles, risk mitigation recommendations, and risk alerts to insurance provider computer device 122. Insurance provider computer device 122 may be any computer device, computer system, or computer server managed by an insurance provider or insurance-related organization. For example, CRM computing device 102 may transmit risk profiles to insurance provider computer device 122 such that the risk profiles may be used in determining insurance plans or offering insurance-related rewards.

In the exemplary embodiment, CRM computing device 102 may be further configured to receive data from and transmit data to database 124. In the exemplary embodiment, database 124 may be external from CRM computing device 102, and CRM computing device 102 communicates with database 124 through a database server. In the exemplary embodiment, CRM computing device 102 may include a local memory for storing data. In an alternative embodiment, database 124 may be local to CRM computing device 102.

CRM computing device 102 may be configured to store any of the data transmitted through CRM computer system 100 on database 124 and subsequently access that data. Additionally, CRM computing device 102 may be configured to retrieve any data necessary for operations within CRM computer system 100 from database 124. In alternative embodiments, database 124 may include multiple databases, such as a buildings database, city database, user database, events database, and insurance database.

### Exemplary Computer System Data Flow for Analyzing and Mitigating Building-Related Risk

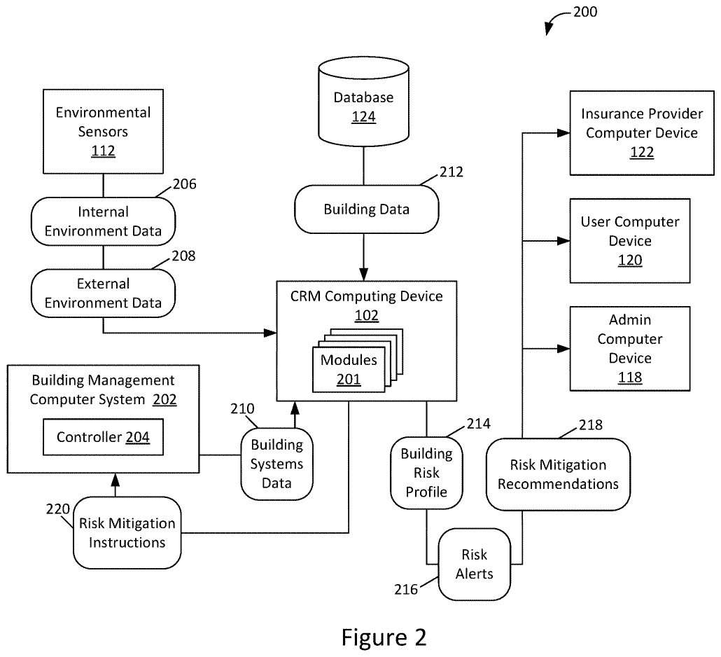

FIG. 2 is a block diagram illustrating a data flow using an exemplary city risk mitigation (“CRM”) computer system 200, configured to analyze and mitigate building-related risk associated with a building in a city, community, or other group of people. CRM computer system 200 may include CRM computing device 102 including modules 201, environmental sensors 112, admin computer device 118, user computer device 120, insurance provider computing device 122, database 124, and building management computer system 202 including controller 204 (which may be similar to third party computer system 114 and controller 116 respectively, both shown in FIG. 1).

In the exemplary embodiment, CRM computing device 102 may utilize modules 201 (which are similar to modules 104-110, shown in FIG. 1). CRM computing device 102 may be configured to receive internal environment data 206 and external environment data 208 from environmental sensors 112. CRM computing device 102 may be further configured to receive building systems data 210 from building management computer system 202 and to receive building data 212 from database 124. CRM computing device may be further configured to generate building risk profile 214 based upon the received data and transmit building risk profile 214 to at least one of admin computer device 118, user computer device 120, and insurance provider computer device 122. CRM computing device 102 may also be configured to generate risk mitigation alerts 216 and risk mitigation recommendations 218 based upon building risk profile 214 and the received data and transmit risk mitigation alerts 216 and risk mitigation recommendations 218 to at least one of admin computer device 118, user computer device 120, and insurance provider computer device 122. CRM computing device 102 may be further configured to generate risk mitigation instructions 220 based upon building risk profile 214 and the received data, and transmit risk mitigation instructions 220 to building management computer system 202.

In the exemplary embodiment, CRM computing device 102 may receive environment data from environmental sensors 112. Specifically, CRM computing device may be configured to receive internal environment data 206 related to an internal building environment and external environment data 208 related to the environment external to the building. Environmental sensors 112 may include a plurality of sensors and/or a plurality of sensor networks.

Internal environment data 206 and external environment data 208 may come from environmental sensors 112 that are part of the same sensor network, or part of distinct sensor networks. Internal environment data 206 and external environment data 208 may include, but are not limited to, temperature, humidity, vibrations, motion sensor data, audio, video, images, pressure readings, smoke detection, water detection, head counts, thermal readings, Lidar data, sonar data, radar data, spectroscopy data, x-ray data, weather data, precipitation data, wind data, collision data, pollution data, acidity levels, stress detection data, and any other type of data related to the internal environment of a building and the external (outside) environment.

In one embodiment, environmental sensors 112 may include systems for testing the strength and wear of materials that make up a building. Specifically, environmental sensors 112 include stress, strength, strain, image recognition, x-ray, or any other type of sensors that may collect data regarding the strength or wear of the buildings materials. Additionally, environmental sensors 112 may include a means for applying stresses, chemicals, water, pressure, or other stressors to particular building materials such that the response can be measured with sensors such as those described above. In other words, environmental sensors 112 may include both a means for testing building materials and sensors for recording the response of the building materials. For example, environmental sensors 112 may apply liquid to a test portion of a steel I-beam used in construction of a building. Over time, environmental sensors 112 may collect data on the reaction of the I-beam to singular or continued applications of the liquid. Data related to these tests may be included as part of internal environment data 206 or external environment data 208.

In the exemplary embodiment, CRM computing device 102 may be further configured to communicate with building management computer system 202. Building management computer system 202 may include controller 204. CRM computing device 102 may be configured to receive building systems data 210 from building management computer system 202. Building management computer system 202 may be any computer system for monitoring and/or managing aspects of a building or building-related system. For example, building management computer system 202 may include a sprinkler system, a security system, a fire detection system, an earthquake detection system, an energy usage/management system, a water usage/management system, a recycling/waste monitoring system, an internal climate control system, or any other system related to an aspect of the building. Building management computer system 202 may include one or multiple building management systems and may further include one or a plurality of networked building management systems.

In the exemplary embodiment, CRM computing device 102 may be configured to receive building systems data 210 from building management computer system 202, where building systems data 210 includes any data collected by building management computer system 202. Building systems data 210 may include, for example, the health or status of the system (e.g., “online”, “offline”, “operational”, “error”, etc.), the health or status of individual elements of the system, real-time or historical data measurements taken by the system, or any other data utilized by building management computer system 202.

For example, building systems data 210 for a sprinkler system may include status/health of all the sprinklers, locations of all sprinkler heads, available water supply, status of water supply, current levels of heat and/or smoke detection, among other data points. As another example, building systems data 210 for a security system may include status/health of motion detectors, locations of motion detectors, state of all doors and windows, locations at which security clearance is required, and occupants in each room of the building, among other data points.

In the exemplary embodiment, CRM computing device 102 may be further configured to receive building data 212 from database 124. Building data 212 may include any data associated with a building, such as floor plans, a bill of materials, age of the building, renovation history, damage and repair history, a maintenance record, a 3D model of the building, building blueprints, building systems data or any other data related to the building.

In the exemplary embodiment, CRM computing device 102 may be configured to analyze internal environment data 206, external environment data 208, building systems data 210, and building data 212 and generate a building risk profile 214. More specifically, CRM computing device 102 may be configured to utilize machine learning models to analyze the various types of data, recognize patterns in the data, determine potential risks, and generate building risk profile 214 detailing the potential risks. In the exemplary embodiment, CRM computing device 102 transmits building risk profile 214 to admin computer device 118 and/or insurance provider computer device 122.

As an example, external environment data 208 may indicate high levels of wind and rain, and building data 212 may indicate certain portions of the building were constructed from materials that are relatively more susceptible to wind and rain. CRM computing device 102 may then generate a building risk profile indicating the areas of the building that may be at risk of wind and rain damage.

As another example, internal environment data 206 may include evidence of standing water in a certain area of a building for a prolonged period of time, and building data 212 may indicate that no maintenance was done to repair water damage. CRM computing device 102 may then generate a building risk profile indicating potential unresolved water damage in the analyzed location.

As yet another example, external environment data 208 may indicate movement or motion around certain areas of the building at night, and building systems data 210 may indicate the presence of security guards and motion sensor cameras. Further, building data 212 may indicate locations of doorways and windows in the building. CRM computing device 102 may determine that certain external activity late at night occurs near a relatively unguarded doorway into the building and may generate a building risk profile indicating the potential security threat.

In the exemplary embodiment, CRM computing device 102 may be configured to utilize building risk profile 214 and the aforementioned received data to generate risk alerts 216 and risk mitigation recommendations 218. In other words, CRM computing device 102 may be configured to analyze building risk profile 214 and other received data, identify patterns, predict outcomes, and generate risk alerts 216 and risk mitigation recommendations 218. In one embodiment, CRM computing device 102 may be configured to utilize a trained machine learning model to analyze data and generate alerts and recommendations. For example, CRM computing device 102 may analyze data, identify a risk deemed important and generate risk alerts and risk mitigation recommendations. Risk alerts 216 include any alert, notification, email, message, or other means of communication meant to bring notice to a particular risk, a set of risks, or building risk profile 214.

In one embodiment, risk alerts 216 and risk mitigation recommendations 218 are generated in tandem and transmitted to admin computer device 118 and/or insurance provider computer device 122. In alternative embodiments, risk alerts 216 and/or risk mitigation recommendations 218 may be transmitted to building management computer system 202.

Continuing the above-referenced example in which un-repaired standing water was detected and detailed in a building risk profile, CRM computing device 102 may generate a risk alert indicating potential water damage was detected and further generate a risk mitigation recommendation indicating that the area of damage should be inspected. CRM computing device 102 may then transmit the alert and the recommendation to admin computer device 118, such that a user may be able to make a final determination on how to proceed. In a similar example, CRM computing device 102 may be able to definitively determine unresolved water damage, and the recommendation may indicate not only that the area needs to be inspected, but that repairs are needed. Continuing the above-referenced example in which a potential security risk was determined and detailed in a building risk profile, CRM computing device 102 may generate a risk alert indicating the potential security risk and may generate a risk mitigation recommendation suggesting installing additional motion sensors or cameras near the area of concern.

In one embodiment, CRM computing device 102 may be configured to utilize 3D models for analyzing and mitigating potential risks associated with a building. CRM computing device 102 may receive building data 212 in the form of a 3D model and/or may generate a new 3D model of the building. In one embodiment, CRM computing device 102 may be configured to generate building risk profile 214 based upon a 3D model, such that building risk profile 214 includes a 3D model of the building embedded or overlaid with risk information. In another embodiment, CRM computing device 102 may be configured to generate risk mitigation recommendations 218 that include recommended renovations, additions, and/or demolitions, and CRM computing device 102 is further configured to generate 3D models detailing the renovations, additions, and/or demolitions.

In yet another embodiment, CRM computing device 102 may be configured to generate risk mitigation instructions 220 that include instructions for 3D printing a stored 3D model. For example, CRM computing device 102 may determine a recommended building renovation, generate a 3D model detailing the renovation, and transmit instructions to a 3D printing system that causes the 3D printing system to print the 3D model of the renovated building.

In the exemplary embodiment, CRM computing device 102 may be configured to generate risk mitigation instructions 220 based upon building risk profile 214 and/or any received data. Risk mitigation instructions 220 are computer-executable instructions for implementing some action on a computer system. CRM computing device 102 may be configured to generate risk mitigation instructions 220 and transmit risk mitigation instructions 220 to building management computer system 202 such that controller 204 carries out an action indicated in risk mitigation instructions 220. In some embodiments, building management computer system 202 verifies and reviews risk mitigation instructions 220 before implementing the actions indicated therein.

In other embodiments, CRM computing device 102 transmits risk mitigation recommendations 218 to building management computer system 202, and risk mitigation recommendations 218 are used as the basis for implementing a change within building management computer system 202. In the exemplary embodiment, CRM computing device 102 utilizes risk mitigation module 110 to analyze building risk profile 214 and previously received data, recognize patterns within the data, determine potential risks, determine implementations for mitigating those risks, and generate risk mitigation instructions 220.

Continuing the above-referenced example in which a security risk was detected by CRM computing device 102 and a risk alert and risk mitigation recommendation were generated and transmitted, CRM computing device 102 may further generate risk mitigation instructions and transmit the risk mitigation instructions to the security system. The risk mitigation instructions may cause the security cameras to re-align their field of vision so as to more effectively monitor the area of concern. Similarly, the risk mitigation instructions may re-define security guard routes so as to route a security guard past the area of concern on a regular basis.

In alternative embodiments, risk mitigation instructions 220 may cause building management computer system 202 and/or controller 204 to perform risk-mitigation actions including, but not limited to, halting the operation of certain computer or mechanical systems (e.g., halting operating of a manufacturing process taking place in an unsafe environment inside of a building; or halting the operation of an unsafe elevator), rebooting systems (e.g., power cycling a security system in an attempt to reduce security card reader errors), activating or deactivating certain systems (e.g., activating an offline security system; or deactivating a misfiring sprinkler system), or altering operations of a system (e.g., altering the camera angles of cameras in a security system; or rerouting water flow through an alternative drainage system).

### Exemplary Computer System Data Flow for Analyzing and Mitigating City-Related Risk

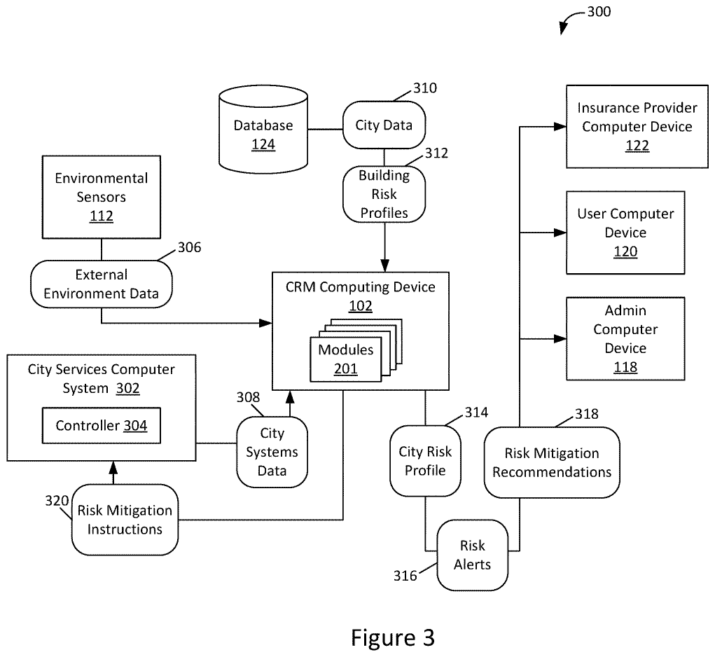

FIG. 3 is a block diagram illustrating a data flow using an exemplary city risk mitigation (“CRM”) computer system 300, which is configured to analyze and mitigate city-related risk, or risk related to another type of community or group of people. CRM computer system 300 may include CRM computing device 102 including modules 201, environmental sensors 112, admin computer device 118, user computer device 120, insurance provider computing device 122, database 124, and city services computer system 302 including controller 304 (which may be similar to third party computer system 114 and controller 116 respectively, both shown in FIG. 1).

In the exemplary embodiment, CRM computing device 102 may utilize modules 201 (which are similar to modules 104-110, shown in FIG. 1). CRM computing device 102 may be configured to receive external environment data 306 from environmental sensors 112. CRM computing device 102 may be further configured to receive city systems data 308 from city services computer system 302 and to receive both city data 310 and building risk profile 312 from database 124. CRM computing device 102 may be further configured to generate city risk profile 314 based upon the received data and transmit city risk profile 314 to at least one of admin computer device 118, user computer device 120, and insurance provider computer device 122.

CRM computing device 102 may also be configured to generate risk mitigation alerts 316 and risk mitigation recommendations 318 based upon city risk profile 314 and the received data and transmit risk mitigation alerts 316 and risk mitigation recommendations 318 to at least one of admin computer device 118, user computer device 120, and insurance provider computer device 122. CRM computing device 102 may be further configured to generate risk mitigation instructions 320 based upon city risk profile 314 and the received data, and transmit risk mitigation instructions 320 to city services computer system 302.

In the exemplary embodiment, CRM computing device 102 may be configured to receive external environment data 306 from environmental sensors 112. External environment data 306 may be similar to external environment data 208, which is described in more detail with regard to FIG. 2 above. In the exemplary embodiment, environmental sensors 112 may constitute a network of environmental sensors spread across multiple locations of a city, such that environmental sensors 112 may capture external environment data 306 detailing conditions across the entire city or a broad portion of the city.

For example, environmental sensors 112 may include a network of wind and precipitation sensors placed on buildings in various locations in a city, such that external environment data 306 may include measurements of wind and precipitation levels at multiple points across an entire city over time. As another example, environmental sensors 112 may include a network of cameras and/or motion sensors at various locations in a city, such that external environment data 306 may include data indicating foot traffic and vehicle traffic through various parts of the city.

In the exemplary embodiment, CRM computing device 102 may be further configured to communicate with city services computer system 302, which includes controller 304. CRM computing device 102 may receive city systems data 308 from city services computer system 302, where city systems data 308 includes any data collected or used by city services computer system 302. City services computer system 302 may monitor and manage some aspect of a city-related service, such as the deployment of emergency vehicles, the management of police forces, scheduling and operations of public transportation, operations of traffic signals, scheduling of construction in the city, monitoring weather reports, or any other privately or publicly managed operation, project, or data collection related to the city as a whole or a portion of the city. In other words, city services computer system 302 may be any computer system associated with a city-related project, service, operation, or data collection, and city systems data 308 may include any data utilized or collected by city services computer system 302. City systems data 308 may include, for example, status and/or health of a fleet of emergency vehicles or police vehicles, reports including locations and times of criminal activity gathered by a police force, weather reports collected by city-owned or third party weather monitoring systems, traffic data and/or health and status of traffic signals, public transportation schedules and operations, and any other data related to city services computer system 302.

In the exemplary embodiment, CRM computing device 102 may be further configured to receive building risk profiles 312 and city data 310 from database 124. Building risk profiles 312 may include any number of building risk profiles, such as building risk profile 214 as described above with reference to FIG. 2. City data 310 may be any data related to a city, including but not limited to, a city layout, a 3D model of a city or a portion of the city, geological data associated with the city, climate reports associated with the city, a map of the city or a portion of the city, comprehensive street maps, business and economic data, locations of emergency services, hospitals, or other public services, and any other data associated with the city. In some embodiments, city data 310 is historical data, real-time data, or a combination of both.

In the exemplary embodiment, CRM computing device 102 may be configured to analyze external environment data 306, city systems data 308, city data 310, and building risk profile 312 and generate city risk profile 314. Specifically, CRM computing device 102 may be configured to analyze received data and recognize patterns, predict future outcomes, determine potential risks, and generate city risk profile 314 detailing the potential risks. In the exemplary embodiment, CRM computing device 102 utilizes risk analysis module 108 to analyze data and generate city risk profile 314. In the exemplary embodiment, CRM computing device 102 utilizes a trained machine learning model for analyzing data, predicting outcomes, and determining potential risks (described in more detail with reference to FIG. 6 below).

In one embodiment, city risk profile 314 may include a computer-generated visualization of city risk, which may be a 2D representation or a 3D model. For example, city risk profile 314 may include a heat map of the city, with riskier (e.g., more dangerous) areas of the city visualized as a hotter color, while less risky areas of the city are visualized as a colder color. Similarly, specific buildings may be hotter or colder depending on individual building risk profiles. The heat map may be in the form of a 2D or 3D city model.

In another embodiment, city risk profile 314 comprises a plurality of building risk profiles 312 mapped to a layout of the city, such that city risk profile 314 is an aggregate of building risk profiles 312. In another embodiment, CRM computing device 102 generates a risk-score for the city and/or portions of the city, and includes the risk scores in city risk profile 314. In alternative embodiments, city risk profile 314 may be generated based upon any of external environment data 306, city systems data 308, city data 301, and building risk profiles 312, alone or in any combination.

As an example, CRM computing device 102 may receive building risk profiles 312 and city data 310, and CRM computing device 102 may plot the locations of buildings as described in building risk profiles 312 onto a city map provided in city data 310. CRM computing device 102 may further determine the density of “condemned” buildings in different areas of the city, and generate city risk profile 314 indicating higher risk in areas of the city with a higher density of condemned buildings.

As another example, CRM computing device 102 may receive city systems data 308 detailing health status and maintenance reports for a public transportation system. CRM computing device 102 may determine that certain public transportation routes contain equipment that has not been serviced for an extended period of time and therefore may be relatively less safe during adverse weather events. CRM computing device 102 may further generate city risk profile 314 indicating risk levels of different public transportation routes.

As another example, CRM computing device 102 may receive external environment data 306 indicating historical weather data, city systems data 308 indicating emergency services responses to traffic accidents over time, and city data 310 indicating the street layout of a city. CRM computing device 102 may correlate adverse weather events with emergency services responses and determine which streets and areas of the city are particularly dangerous given an adverse weather event. CRM computing device 102 may generate city risk profile 314 indicating these risks.

In another embodiment, CRM computing device 102 may be configured to generate and utilize 3D models to analyze city-related risks and generate city risk profile 314. For example, city data 310, building risk profile 312, and/or city systems data 308 may include 3D models and/or may be mapped onto a 3D model by CRM computing device 102. CRM computing device 102 may further utilize other data, such as external environment data 306 and city systems data 308, to determine risks associated with the city based on the 3D model.

In one embodiment, CRM computing device 102 may generate or receive a 3D model of a city layout and run simulations within the 3D model to determine areas of risk. For example, CRM computing device 102 may run a simulation of a thunderstorm within the 3D model and analyze the effect on the buildings represented in the 3D model.

In another embodiment, CRM computing device 102 utilizes data related to planned, upcoming, or not yet completed construction. For example, city data 310, city systems data 308, and/or building risk profiles 312 may include data related to newly planned construction within the city, such as, but not limited to, new building plans, new neighborhood plans, plans for a new group of buildings, or plans for any other type of construction.

CRM computing device 102 may be configured to generate a 3D model representing the completed construction project and analyze risks that may be associated with planned construction. For example, CRM computing device 102 may receive a 3D model for plans of a new building, and the 3D model of the new building to an existing city layout, and run a simulation to determine how wind speeds in the area will be affected by the addition of the building. As another example, CRM computing device 102 may receive plans for a new building and determine the affect the new building may have on security of surrounding buildings (e.g., is the building creating blind-spots for existing security camera systems or is the building creating a dark, narrow alley-way adjacent to another building?).

In the exemplary embodiment, CRM computing device 102 may be configured to analyze city risk profile 314 along with the received data to generate risk alerts 316 and risk mitigation recommendations 318. CRM computing device 102 may be further configured to transmit at least one of risk alerts 316 and risk mitigation recommendations 318 to at least one of admin computer device 118, user computer device 120, and insurance provider computer device 122 in the form of messages, emails, text messages, alerts, or any other means for indicating the message to a user of a computer system.

In some embodiments, CRM computing device 102 may generate alternative risk alerts 316 and risk mitigation recommendations 318 based upon an intended recipient. For example, risk alerts 316 and risk mitigation recommendations 318 intended for user computer device 120 may be in the form of text messages, while the alerts and recommendations intended for admin computer device 118 may be in the form of emailed status reports.

In the exemplary embodiment, CRM computing device 102 utilizes a trained machine learning model to analyze potential risks and determine solutions to those risks. In other words, based upon city risk profile 314 and other received data, CRM computing device 102 may determine risk alerts 316 and risk mitigation recommendations 318 using a trained machine learning model.

In some embodiments, risk alerts 316 and risk mitigation recommendations 318 may be generated when potential risks in city risk profile 314 reach a certain threshold. For example, if potential risks are given a risk score, CRM computing device 102 may generate risk alert 316 when the risk score reaches a certain value.

In some embodiments, risk alerts 316 and risk mitigation recommendations 318 may be generated based upon historical responses to risk. For example, CRM computing device 102 may determine that certain streets have been closed in response to negative weather events, and risk mitigation recommendations 318 may recommend not traveling on certain streets in bad weather.

In one embodiment, CRM computing device 102 may be configured to utilize 3D models for analyzing and mitigating potential risks associated with a city. CRM computing device 102 may receive city data 310 in the form of a 3D model and/or may generate a new 3D model of the city or parts of the city. In one embodiment, CRM computing device 102 is configured to generate city risk profile 314 based upon a 3D model, such that city risk profile 314 includes a 3D model of the city embedded or overlaid with risk information.

In another embodiment, CRM computing device 102 may be configured to generate risk mitigation recommendations 318 that include recommended renovations, additions, and/or demolitions, and CRM computing device 102 is further configured to generate 3D models detailing the renovations, additions, and/or demolitions. In yet another embodiment, CRM computing device 102 may be configured to generate risk mitigation instructions 320 that include instructions for 3D printing a stored 3D model. For example, CRM computing device 102 may determine a recommended city renovation project, generate a 3D model detailing the renovation project, and transmit instructions to a 3D printing system that causes the 3D printing system to print the 3D model of the renovated city.

Continuing the above-referenced example of public transportation risk during adverse weather events, CRM computing device 102 may further receive external environment data 306 indicating high levels of precipitation and sub-freezing temperatures. Additionally, CRM computing device 102 may receive city systems data 308 including weather reports that indicate snow is on the forecast. CRM computing device 102 may analyze city risk profile 314 along with the weather reports and sensor data and determine that potentially risky public transportation routes are at an especially high risk-level given the weather. CRM computing device 102 may generate risk mitigation alerts 316 and risk mitigation recommendations 318 advising against the use of specific public transportation routes given the weather. CRM computing device 102 may further transmit the risk alerts 316 and the risk mitigation recommendations 318 to admin computer device 118 and user computer device 120.

In the exemplary embodiment, CRM computing device 102 may be configured to analyze city risk profile 314 and other received data and generate risk mitigation instructions 320. CRM computing device 102 may be further configured to transmit risk mitigation instructions 320 to city services computer system 302. Risk mitigation instructions 320 may be computer-executable instructions for implementing some action on a computer system. CRM computing device 102 may be configured to generate risk mitigation instructions 320 and transmit risk mitigation instructions 320 to city services computer system 302 such that controller 304 carries out an action indicated in risk mitigation instructions 320.

In some embodiments, city services computer system 302 verifies and reviews risk mitigation instructions 320 before implementing the actions indicated therein. In other embodiments, CRM computing device 102 may transmit risk mitigation recommendations 318 to city services computer system 302, and risk mitigation recommendations 318 are used as the basis for implementing a change within city services computer system 302.

In the exemplary embodiment, CRM computing device 102 utilizes risk mitigation module 110 to analyze city risk profile 314 and previously received data, recognize patterns within the data, determine potential risks, determine implementations for mitigating those risks, and generate risk mitigation instructions 320.

Continuing the above-referenced example of public transportation risk during adverse weather events, CRM computing device 102 may further generate and transmit risk mitigation instructions 320 to the public transportation system, such that risk mitigation instructions 320 cause the public transportation system to halt service on certain routes that are deemed too risky by CRM computing device 102.

In alternative embodiments, risk mitigation instructions 320 may cause city services computer system 302 and/or controller 304 to perform risk-mitigation actions including, but not limited to, halting the operation of certain computer or mechanical systems (e.g., halting operation of a public transportation system deemed unsafe; or halting the operation of industrial machinery deemed unsafe), rebooting systems (e.g., power cycling city security systems in an attempt to reduce security card reader errors), activating or deactivating certain systems (e.g., activating an offline security system; or deactivating a damaged power grid), or altering operations of a system (e.g., re-routing public transportation vehicles through safer routes; or altering traffic signals in order to re-route traffic through safer areas).

### Exemplary Computer System for Analyzing and Mitigating Risk Associated with a User

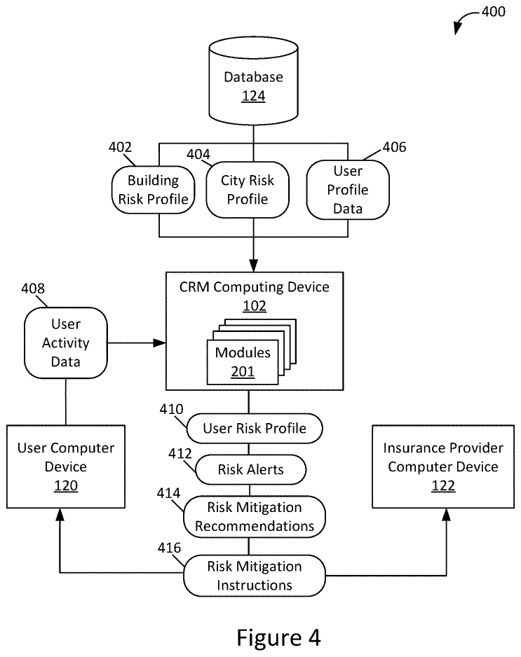

FIG. 4 is a block diagram illustrating a data flow using an exemplary city risk mitigation (“CRM”) computer system 400, which is configured to analyze and mitigate risk associated with an individual user or group of users. CRM computer system 400 may include CRM computing device 102 including modules 201, user computer device 120, insurance provider computer device 122, and database 124.

In the exemplary embodiment, CRM computing device 102 may utilize modules 201 (which are similar to modules 104-110, shown in FIG. 1). CRM computing device 102 may be configured to receive building risk profile 402, city risk profile 404, and user profile data 406 from database 124. CRM computing device 102 may be further configured to receive user activity data 408 from user computer device 120. CRM computing device 102 may be configured to generate user risk profile 410 based upon the received data and transmit user risk profile 410 to at least one of user computer device 120 and insurance provider computer device 122.

CRM computing device 102 may also be configured to generate risk alerts 412 and risk mitigation recommendations 414 based upon user risk profile 410 and the received data and transmit risk alerts 412 and risk mitigation recommendations 414 to at least one of user computer device 120 and insurance provider computer device 122. CRM computing device 102 may be further configured to generate risk mitigation instructions 416 based upon user risk profile 410 and other received data, and transmit risk mitigation instructions 414 to at least one of user computer device 120 and insurance provider computer device 122.

In the exemplary embodiment, CRM computing device 102 may be configured to receive building risk profile 402, city risk profile 404, and user profile data 406 from database 124. In alternative embodiments, CRM computing device 102 may receive any of building risk profile 402, city risk profile 404, and user profile data 406 in any amount or combination. Building risk profile 402 details potential risks associated with a building and may be similar to building risk profile 312 (shown in FIG. 3) and building risk profile 214 (shown in FIG. 2), which are described in more detail with regard to FIG. 3. City risk profile 404 details potential risks associated with a city or a portion of a city and may be similar to city risk profile 314 (shown in FIG. 3), which is described in more detail with regard to FIGS. 3 and 4.

User profile data 406 may include any data associated with a particular user or group of users of CRM computer system 400. Specifically, user profile data 406 may include, but is not limited to, sex, gender, age, demographic information, insurance plan information, income, behavioral tendencies, modes of transportation, employment information, medical information, or any other information associated with the user or group of users.

In the exemplary embodiment, CRM computing device 102 may be configured to receive user activity data 408 from user computer device 120. User activity data 408 includes any data associated with the activities, behaviors, and/or actions of a user. User activity data 408 may include, but is not limited to, location data (e.g., GPS location data), internet connection activity, rate of travel, means of transportation, driving routes, time spent in given locations, activities undertaken in given locations, scheduled events and appointments, reservations at restaurants or other venues, or any other data associated with the activities of a user.

In one embodiment, CRM computing device 102 may receive user activity data 408 from user computer device 120 in real-time or nearly real-time, such as through wireless transmissions on a satellite network. In another embodiment, CRM computing device 102 receives user activity data 408 from user computer device 120 at specific intervals, or when user computer device 120 connects to a Wifi network. In another embodiment, CRM computing device 102 retrieves user activity data 408 from user computer device 120 when a certain function is being carried out by CRM computing device 102.

In the exemplary embodiment, CRM computing device 102 may be configured to analyze building risk profile 402, city risk profile 404, user profile data 406, and user activity data 408, and generate a user risk profile 410 detailing potential risks associated with the user. In one embodiment, CRM computing device 102 may be configured to recognize patterns, predict future outcomes, determine potential risks associated with a user, and detail the potential risks and outcomes in user risk profile 410. In one embodiment, CRM computing device 102 gives user activities and behaviors risk-scores and the risk-scores are detailed in user risk profile 410.

For example, user profile data 406 may include information that a user is elderly and in a wheelchair, and at least one of building risk profile 402 and city risk profile 404 may indicate areas in a building or city that are not wheelchair accessible. CRM computing device 102 may determine that these areas present risk to a user, and include these potential risks in a user risk profile.

In another example, user activity data 408 may include a list of locations and times of a user's daily schedule and based upon dangerous parts of the city indicated in city risk profile 404, CRM computing device 102 may give risk scores to each hour of the user's day, based upon what part of the city the user was in at that time. In another example, user activity data 408 may include a list of activities a user participates in in different parts of the city, such as a soccer game in location A and volunteering at a soup kitchen in location B.

Based upon city risk profile 404 and building risk profile 402, CRM computing device 102 may give risk scores to each user activity based upon the riskiness of the activity, location, building, and time. For example, soccer in location A may be more or less risky based upon the neighborhood of location A, and volunteering in the soup kitchen at location B may be more or less risk based upon the neighborhood of location B and the building in which the kitchen is housed. In another embodiment, CRM computing device 102 determines potentially risky behaviors (e.g., by determining risk scores that meet a threshold value) and flags the potentially risky behaviors in the user risk profile 410.

In one embodiment, CRM computing device 102 determines risk (e.g., a risk score) for each user activity as a combination of multiple factors including the activity itself, the location of the activity, the timing of the activity, and the particular user partaking in the activity. Specifically, CRM computing device 102 may determine that certain activities are inherently more or less risky than other activities. Sky-diving, for example, may be rated significantly more risky than playing a soccer game. Similarly, biking may be ranked as more risky than driving.

CRM computing device 102 may also consider the location of the activity in determining a risk-score for the activity. For example, biking in a certain busy areas of the city may be significantly more risky than biking in other, less busy areas of the city. Similarly, CRM computing device 102 may consider the timing of the activity in determining riskiness. For example, biking during rush-hour may be more risky than biking during off-hours.

Additionally, CRM computing device 102 may utilize information about the specific user in determining the riskiness of an activity. For example, a senior citizen or a user with poor vision may experience higher-risk while driving at night.

In the exemplary embodiment, CRM computing device 102 may be configured to generate risk alerts 412, risk mitigation recommendations 414, and risk mitigation instructions 416 based upon the received data and risk profile 410. CRM computing device 102 may be further configured to transmit risk alerts 412, risk mitigation recommendations 414, and risk mitigation instructions 416 to user computer device 120 and insurance provider computer device 122.

In one embodiment, CRM computing device 102 may be configured to generate risk alerts 412, risk mitigation recommendations 414, and/or risk mitigation instructions 416 when the risk score for a particular activity reaches a certain threshold. In another embodiment, CRM computing device 102 may be configured to generate risk alerts 412, risk mitigation recommendations 414, and/or risk mitigation instructions 416 when a certain level of risk is detected within user risk profile 410 as a whole, or when user risk profile 410 as a whole reaches a certain risk score threshold. In alternative embodiments, CRM computing device 102 may be configured to generate any number of risk alerts 412, risk mitigation recommendations 414, and risk mitigation instructions 416 in any combination based upon specific user activities, elements of user risk profile 410, or the entirety of user risk profile 410.

In the exemplary embodiment, CRM computing device 102 may be configured to generate risk alerts 412 in order to alert or notify a user or a computer system of a particular element of risk detected by CRM computing device 102. Risk alerts 412 may be an email, text message, report, notification, or any other form of communication intended to notify or alert a user or a computer system of an element of risk. For example, CRM computing device 102 may determine that a user is attempting to travel on a public transportation route that CRM computing device 102 has determined is unsafe. CRM computing device 102 may update user risk profile 410 with the user activity, determine that the user activity has a risk score above a certain threshold, and send a risk alert to the user indicating that the activity may be unsafe. In a similar example, CRM computing device 102 may receive user activity data indicating that the user is biking through a part of town with a high risk score in the city risk profile. CRM computing device 102 may generate a risk score for the activity, update user risk profile 410 with the activity, determine the risk score is above a certain threshold, and send a risk alert to the user and/or an insurance provider indicating the activity is potentially unsafe.

In the exemplary embodiment, CRM computing device 102 may be configured to generate risk mitigation recommendations 414 in order to provide recommended alternative activities or recommended actions for mitigating risk. Risk mitigation recommendations 414 may be in the form of email, text message, notification message, attached document, to-do list, warning message, or any other form that allows a user or a computer system to access the recommended risk-mitigating activities of risk mitigation recommendations 414. Continuing the above example for which a user is attempting to travel on an unsafe public transportation route, in addition to sending a risk alert to the user, CRM computing device 102 may additionally send risk mitigation recommendations including a recommended alternative public transportation route or alternative mode of transportation. In another example, CRM computing device 102 may receive user activity data indicating the user is attempting to drive through a part of town with a high level of accidents at a certain time of day. CRM computing device 102 may analyze a city risk profile and user activity data (including the driving route and time of day) to determine the potentially risk driving route the user intends to take, and CRM computing device 102 may determine and generate risk mitigation recommendations including an alternative driving route for the user.

In the exemplary embodiment, CRM computing device 102 may be configured to generate risk mitigation instructions 416 in order to automatically induce a risk mitigating action within a physical or computer system. Risk mitigation instructions 416 are computer-readable instructions, which, when executed by a computer processor, cause the processor to implement some action indicated in risk mitigation instructions 416. For example, continuing the above example where a user is attempting to undertake a dangerous driving route, CRM computing device 102 may determine a less risky driving route and generate risk mitigation instructions which, when transmitted to user computer device 120, cause a navigation application on user computer device 120 to automatically re-route the user through the safer route.

As another example, CRM computing device 102 may determine, by analyzing user activity data, that a user has changed schedules and now takes public transportation to work instead of driving. CRM computing device 102 may determine that taking public transportation is significantly safer than driving to work for the given user and the given route, and CRM computing device 102 may update the user's user risk profile to indicate the less risky behavior. CRM computing device 102 may generate a risk mitigation recommendation indicating that continued use of public transportation is safer for the user and transmit the recommendation to the user. Additionally, CRM computing device 102 may generate a risk mitigation recommendation for insurance provider computer device 122 indicating that the reduced risk incurred by the user may entitle the user to reduced car insurance rates. In another example, CRM computing device 102 generates and transmits risk mitigation instructions to insurance provider computer device 122 that causes insurance rates to be lowered for a user based upon the reduced risk in the user risk profile.

### Exemplary Computer System for Analyzing and Mitigating Risk Associated with an Event

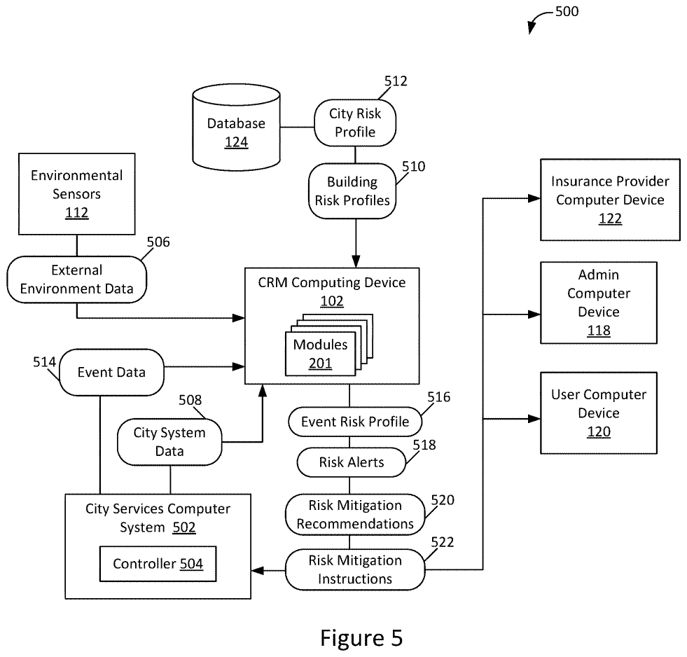

FIG. 5 is a block diagram illustrating a data flow using an exemplary city risk mitigation (“CRM”) computer system 500, which may be configured to analyze and mitigate risk associated with an event. CRM computer system 500 may include CRM computing device 102 including modules 201, environmental sensors 112, admin computer device 118, user computer device 120, insurance provider computer device 122, database 124, and city services computer system 502 including controller 504. In the exemplary embodiment, city services computer system 502 including controller 504 may include a network of city services computer systems and/or a plurality of separate city services computer systems associated with separate city services.

In the exemplary embodiment, CRM computing device 102 may utilize modules 201 (which are similar to modules 104-110, shown in FIG. 1). CRM computing device 102 may be configured to receive external environment data 506 from environmental sensors 112. CRM computing device may be further configured to receive both system data 508 and event data 514 from city services computer system 502 and both building risk profile 510 and city risk profile 512 from database 124. CRM computing device 102 may be configured to analyze the received data, generate event risk profile 516, and transmit event risk profile 516 to any of user computer device 120, admin computer device 118, and insurance provider computer device 122.

CRM computing device 102 may also be configured to generate risk alerts 518 and risk mitigation recommendations 520 based upon event risk profile 516 and the received data and transmit risk alerts 518 and risk mitigation recommendations 520 to any of city services computer system 502, user computer device 120, admin computer device 118, and insurance provider computer device 122. CRM computing device 102 may be further configured to generate risk mitigation instructions 522 based upon user risk profile 410 and other received data, and transmit risk mitigation instructions 522 to at least one of user computer device 120 and insurance provider computer device 122.

In the exemplary embodiment, CRM computing device 102 may be configured to receive external environment data 506 from environmental sensors 112. External environment data 506 is similar to external environment data 208 and 306 (shown in FIGS. 2 and 3 respectively), which are described in more detail with reference to FIGS. 2 and 3.

In the exemplary embodiment, CRM computing device 102 may be further configured to receive city systems data 508 and event data 514 from city services computer system 502. City systems data 508 is similar to city systems data 308 (shown in FIG. 3), which is described in more detail with reference to FIG. 3. In alternative embodiments, CRM computing device 102 may be in communication with a building management computer system (such as building management computer system 202, shown in FIG. 3) in place of or in combination with city services computer system 502. In alternative embodiments, CRM computing device 102 is in communication with any third party computer system similar to a city services computer system or a building management computer system that enables functionality similar to that described herein. In alternative embodiments, CRM computing device 102 may be configured to receive system data and event data from the same or different third party computer systems.

In the exemplary embodiment, CRM computing device 102 may receive event data 514 from city services computer system 502. Event data 514 may include any data associated with an event, including manmade events and natural disasters. Event data 514 may be collected by sensors associated with city services computer system 502 or received by city services computer system 502 from an external source. Event data 514 may include, but is not limited to, reports of an incoming weather event, reports and data associated with a natural disaster, data associated with city events (e.g., concerts, parades, festivals, etc.), reports of unexpected manmade events (e.g., protests, riots, etc.), reports and data associated with criminal activity, and any other event. Event data 514 may include real-time or nearly real-time data, as well as historical data.

In the exemplary embodiment, CRM computing device 102 may be configured to receive building risk profiles 510 and city risk profile 512 from database 124. Building risk profiles 510 are similar to building risk profiles 402, 312, and 212 (shown in FIGS. 4, 3, and 2 respectively) and are described in more detail with regard to FIGS. 2, 3 and 4. City risk profile 512 is similar to city risk profiles 404 and 314 (shown in FIGS. 4 and 3 respectively) and are described in more detail with regard to FIGS. 3 and 4.

In the exemplary embodiment, CRM computing device 102 may be configured to analyze external environment data 506, city systems data 508, building risk profile 510, city risk profile 512, and event data 514 in order to generate event risk profile 516. More specifically, the CRM computing device 102 may be configured to analyze the received data, recognize patterns in the data, predict future events, identify and/or determine potential risks associated with events, and generate event risk profile 516 detailing the potential risks.

In one embodiment, CRM computing device 102 utilizes a trained machine learning model to process the various data inputs and determine risks associated with the data. In one embodiment, CRM computing device 102 utilizes a machine learning module to train a machine learning model for use in generating event risk profile 516 (machine learning utilized by CRM computing device 102 is described in more detail with regard to FIG. 6 below).

In alternative embodiments, CRM computing device 102 utilizes any number of external environment data 506, city systems data 508, event data 514, building risk profile 510, and city risk profile 512 in any combination to generate event risk profile 516. In one embodiment, CRM computing device 102 analyzes received data both individually and in combination to identify patterns and predict potential risks.

In one embodiment, CRM computing device 102 generates a risk score for events described by event data 514. In other words, CRM computing device 102 predicts a certain level of risk associated with an event and gives the event a risk score based upon the associated risk. The risk score may be based upon a number of factors, including but not limited to, likelihood the event continues, estimated damages from an event, likelihood an event results in damage, varying tiers of damage and likelihoods for each damage outcome, maximum potential risk attributed to a worst case scenario, reliability of systems reporting event data 514, and a variety of other factors that may be used to determine the severity and/or likelihood of a risks associated with an event. For example, CRM computing device 102 may give a risk score of “low” to an event that is unlikely to affect the city, such as an incoming storm with a low possibility of passing through the city.

In another embodiment, CRM computing device 102 determines multiple risk scores associated with various aspects of an event. For example, CRM computing device 102 may determine both a “likelihood risk score” for scoring the likelihood that an adverse event will occur and a “severity risk score” for scoring the potential severity of an adverse event were it to occur. For example, CRM computing device 102 may give an approaching tornado a likelihood risk score of “low” with a severity risk score of “high” after determining that the tornado is unlikely to reach the city but would cause significant damage if it did.

In one embodiment, CRM computing device 102 may be configured to generate event risk profile 516 based upon various aspects associated with the received data. In one embodiment, CRM computing device 102 may generate event risk profile 516 based upon any combination of likelihood of an event, potential severity of an event, ability for city services to handle an event, ability for city infrastructure to handle the event, the location of the event, and the timing of the event. CRM computing device 102 may determine these event-related aspects by analyzing external environment data 506, city systems data 508, event data 514, city risk profile 512, and building risk profile 510.

In an exemplary embodiment, CRM computing device 102 may be configured to determine likelihood of an event based upon external environment data 506 and event data 514. For example, external environment data may indicate increasing winds and a drop in temperature and event data may include weather reports of an incoming storm. CRM computing device 102 may determine that it is likely that the incoming storm will reach the city. In another example, external environment data may include detected motion and video images of crowds of people in a certain area of the city and event data may indicate reports of an incipient riot. CRM computing device 102 may determine that a riot is likely in the indicated locations.

In another embodiment, CRM computing device 102 may be further configured to determine potential severity of an event based upon external environment data 506, event data 514, city systems data 508, city risk profile 512, and building risk profiles 510. For example, external environment data may indicate a significant drop in pressure, and event data may indicate reports of an approaching tornado. City systems data may indicate that emergency services are lacking in the potentially affected region, and the city risk profile and building risk profiles may indicate that the city layout in the potentially affected area is particularly prone to tornado damage, and the buildings in the area are older and/or not as well protected from tornados. Based upon such data points, CRM computing device 102 may determine that severity of the potential event is high.

In the exemplary embodiment, CRM computing device 102 may be configured to generate risk alerts 518, risk mitigation recommendations 520, and risk mitigation instructions 522 based upon event risk profile 516 and other received data. CRM computing device 102 may be further configured to transmit risk alerts 518, risk mitigation recommendations 520 and risk mitigation instructions 522 to at least one of city services computer system 502, admin computer device 118, user computer device 120, and insurance provider computer device 122. Risk alerts 518, risk mitigation recommendations 520, and risk mitigation instructions 522 may be similar to risk alerts 412, risk mitigation recommendations 414, and risk mitigation instructions 416 (shown in FIG. 4), which are described in more detail with regard to FIG. 4.

In one embodiment, CRM computing device 102 is configured to generate alerts 518, recommendations 520, and instructions 522 prior to or simultaneous to generating event risk profile 516. In another embodiment, CRM computing device 102 may be configured to generate outputs based upon received input data in real-time or near real-time. For example, CRM computing device 102 may receive event data 514 from city services computer system 502 in real-time indicating an incipient natural disaster, and CRM computing device 102 may generate alerts, recommendations, and instructions in real-time as data is received.

In the exemplary embodiment, CRM computing device 102 may be configured to generate risk alerts 518 in order to bring attention to a particular event. In one example, CRM computing device 102 may receive precipitation data from environmental sensors 112 indicating rain and event data from city services computer system 502 indicating reports of an incoming storm. Additionally, CRM computing device 102 may receive a city risk profile indicating buildings that are particularly susceptible to storms. CRM computing device 102 may generate risk alerts indicating an incoming storm and transmit the alerts to user computer devices of user's residing in susceptible buildings.

In the exemplary embodiment, CRM computing device 102 may be configured to generate risk mitigation recommendations 520 in order to suggest actions that may enable users or computer systems to mitigate or avoid potential risks entirely. Continuing the above example of buildings susceptible to an incoming storm, CRM computing device 102 may generate and transmit mitigation recommendations along with the risk alerts instructing users to close windows and monitor their buildings for water leaks.

In another example, CRM computing device 102 may receive external environment data and city risk profile data indicating large crowds of people gathering in a specific neighborhood and event data indicating a potential riot. CRM computing device 102 may determine high probability of a riot in a specific location and generate an event risk profile detailing the risk of the event. Additionally, CRM computing device 102 may determine that the risk of the event meets a specific threshold, and in response, may generate risk mitigation recommendations suggesting that people avoid the neighborhoods that may be affected by the riot. CRM computing device 102 may then transmit a risk alert and the risk mitigation recommendations to all user computer devices within a certain range of the potential event.

In the exemplary embodiment, CRM computing device 102 may be configured to generate risk mitigation instructions 522 to automatically implement certain risk mitigation actions in a digital or physical response system. Continuing the above example of the incipient riot, CRM computing device 102 may further generate and transmit risk mitigation instructions to a law enforcement management system such that the risk mitigation instructions cause a certain portion of a police force to remain on standby or be stationed closer to the potential event. As another example, CRM computing device 102 may receive external environment data indicating seismic activity and event data indicating an oncoming earthquake. CRM computing device 102 may further receive building systems data indicating buildings that have particular anti-earthquake measures, and CRM computing device 102 may generate risk mitigation instructions which cause the building system's anti-earthquake measure to activate (e.g., announcing the earthquake to building recipients, locking down movable objects, etc.).

Further, CRM computing device 102 may receive a city risk profile indicating buildings and/or neighborhoods most susceptible to earthquake damage and may generate an event risk profile detailing the possible severity and potential risk of the event for each building in the city. Based upon buildings with the highest potential risk, CRM computing device 102 may further send risk mitigation instructions to an emergency services computer system adding particular buildings as high-priority within the emergency services' job-list.

In alternative embodiments, risk mitigation instructions 522 may cause city services computer system 502 and/or controller 504 to perform risk-mitigation actions including, but not limited to, halting the operation of certain computer or mechanical systems (e.g., halting operation of a public transportation system deemed unsafe; or halting the operation of industrial machinery deemed unsafe), rebooting systems (e.g., power cycling city security systems in an attempt to reduce security card reader errors), activating or deactivating certain systems (e.g., activating an offline security system; or deactivating a damaged power grid), or altering operations of a system (e.g., re-routing public transportation vehicles through safer routes; or altering traffic signals in order to re-route traffic through safer areas).

### Exemplary Module Functionality in a City Risk Mitigation Computer Device

FIG. 6 depicts an exemplary data flow using modules of CRM computing device 102. In the exemplary embodiment, CRM computing device 102 may include communications module 104, machine learning module 106, risk analysis module 108, and risk mitigation module 110. CRM computing device 102 may utilize any number of the described modules in any combination to implement any of the functionality as described herein. Additionally, CRM computing device 102 may utilize any number of additional modules or alternative modules to implement any of the functionality as described herein.

In the exemplary embodiment, communications module 104 configured to enable communications between CRM computing device 102 and any external computer devices as well as enable communication between modules of CRM computing device 102. In one embodiment, communications module 104 acts as a server for connecting CRM computing device 102 to external computer devices and/or databases.

In the exemplary embodiment, machine learning “ML” module 106 may be configured to train risk analysis and mitigation models for use by CRM computing device 102 in analyzing and mitigating risks. In general, ML module 106 enables CRM computing device 102 to “learn” to analyze data, predict outcomes, identify potential risks, and generate risk mitigation outputs. Specifically, ML module 106 is configured to receive an untrained machine learning model 604 along with training data 606, process the training data using machine learning “ML” methods and algorithms 608, and generate a trained machine learning model 610 (e.g., a risk analysis model and/or risk mitigation model) after processing training data 606. In the exemplary embodiment, ML module 106 receives untrained model 604, training data 606, and ML methods and algorithms 608 from database 124.

In one embodiment, untrained model 604 may be any function, decision making model, or prediction model with undefined or under-defined elements (e.g., undefined function coefficients). In the exemplary embodiment, ML module 106 is configured to define the elements of untrained model 604 by processing training data 606 using ML methods and algorithms 608. In one embodiment, ML module 106 is configured to receive and re-define the elements of an already trained ML model.

In the exemplary embodiment, training data 606 may include any real-time or historical data that may be used as an input for training untrained model 604. Training data may be organized (e.g., as in training data used for supervised learning) or unorganized (e.g., as in training data used for unsupervised learning). Specifically, training data 606 may include any of the data inputs mentioned herein with regard to FIGS. 1-5, including, but not limited to: external environment data, internal environment data, building systems data, city systems data, event data, user activity data, building risk profiles, city risk profiles, user risk profiles, event risk profiles, building data, city data, user profile data, risk alerts, risk mitigation recommendations, and risk mitigation instructions.

For example, training data 606 may include historical weather data along with related data of damages incurred after specific weather events. As another example, training data 606 may include measurements of pedestrian activity throughout parts of a city and criminal activity reports over the same time frame. As another example, training data 606 may include city layouts and associated reports of natural disaster damage in different parts of the city. As yet another example, training data 606 may include building materials, stress testing data, and data regarding building damages incurred under particular weather conditions. As yet another example, training data 606 may include historical data of events, risk mitigation actions implemented by an emergency services organization in response to the events, and resulting damages incurred by the events.

In the exemplary embodiment, ML module 106 utilizes ML methods and algorithms 608 to process training data 606 and define the elements of untrained model 604, thereby generating trained ML model 610. In other words, ML module 106 utilizes ML methods and algorithms 608 to identify patterns within data, test predictions of outputs, and define functions (e.g., the elements of untrained model 604) that enable accurate predictions of outcomes based upon novel inputs. For example, ML module 106 may utilize ML methods and algorithms to identify a relationship between organized data such as weather events and associated city damages in specific parts of the city. As another example, ML module 106 may utilize ML methods and algorithms to identify relationships between unorganized data such as weather events, neighborhood layouts, pedestrian foot traffic, and riot events. In the exemplary embodiment, ML module 106 captures these relationships by defining the elements of untrained model 604.

ML module 106 is configured to utilize ML methods and algorithms 608 including, but not limited to, a variety of methods and algorithms such as: linear or logistic regression, instance-based algorithms, regularization algorithms, decision trees, Bayesian networks, cluster analysis, association rule learning, artificial neural networks, deep learning, dimensionality reduction, and support vector machines. ML methods and algorithms 608 are generally directed toward at least one of a plurality of categorizations of machine learning, including supervised learning methods, unsupervised learning methods, and reinforcement learning methods.

In one embodiment, ML module 106 utilizes supervised learning methods, which involve defining relationships in organized and/or labeled data to make predictions about subsequently received data. Using supervised learning, ML module 106 receives training data 606 that includes training inputs and associated training outputs. For example, training data for a model used to predict damages after a natural disaster may include weather reports and images taken after a natural disaster (inputs) along with damage estimates due to the natural disaster (associated outputs). ML module 106 is configured to process training data 606 using supervised learning algorithms and generate trained ML model 610 that effectively maps inputs to outputs. Continuing the above example, trained ML model 610 may be capable of receiving novel inputs of weather reports and images taken after a natural disaster and generating estimated damages.

In another embodiment, ML module 106 utilizes unsupervised learning methods, which involve finding meaningful relationships in unorganized data. Unlike supervised learning methods, unsupervised learning methods do not utilize training data with labeled inputs and associated outputs. Rather, the training data is unorganized, and ML module 106 utilizes unsupervised learning methods to determine or identify relationships within the training data and generate trained ML model 610 that effectively maps these relationships. For example, ML module 106 may receive training data 606 including reports of criminal activity including dates and times, weather reports, and a detailed city map. ML module 106 may process the training data using an unsupervised ML method and identify relationships within the data, such as how weather affects criminal activity in different areas of the city. ML module 106 may then generate trained ML model 610 that predicts the most likely areas of crime when provided with upcoming weather reports.

In the exemplary embodiment, ML module 106 generates trained ML models 610 for use by risk analysis module 1078 and risk mitigation module 110. Specifically, ML module 106 may generate a trained ML model 610 that enables risk analysis module 108 to more accurately analyze risks and a trained ML model 610 that enables risk mitigation module 110 to more accurately generate risk mitigation outputs. In alternative embodiments, ML module 106 generates any number or combination of trained ML models 610 that allow CRM computer device 102 and the modules thereof to function as described.

In the exemplary embodiment, risk analysis module 108 is configured to receive trained ML model 610, where trained ML model 610 is trained to determine potential risks based upon input data 612. Risk analysis module 108 is configured to receive input data 612, utilize trained ML model 610 to process input data 612, and generate risk profile 614 based upon the outputs of trained ML model 610. Risk analysis module 108 is further configured to transmit risk profile 614 to risk mitigation module 110 and external computer device 602. In some embodiments, trained ML model 610 is configured to both determine risks and generate a risk profile. In other embodiments, risk analysis module 108 utilizes separate trained ML models for determining risks and generating risk profiles.

In the exemplary embodiment, risk mitigation module 110 may be configured to receive trained ML models 610 from ML module 106, where trained ML model 610 is trained to determine risk mitigation outputs based upon risk profile 614. mitigation module 110 may be configured to receive risk profile 614, utilize trained ML model 610 to analyze risk profile 614, and generate risk mitigation outputs including risk alerts 616, rick mitigation recommendations 618, and risk mitigation instructions 620 based upon the outputs of trained ML model 610.

In one embodiment, trained ML model 610 analyzes risk profile 614 and generates risk mitigation outputs. In an alternative embodiment, risk mitigation module 110 utilizes multiple trained ML models 610 for analyzing risk profile 614 and generating risk mitigation outputs. Risk mitigation module 110 may be further configured to transmit the risk mitigation outputs to external computer device 602.

### Exemplary User Computer Device

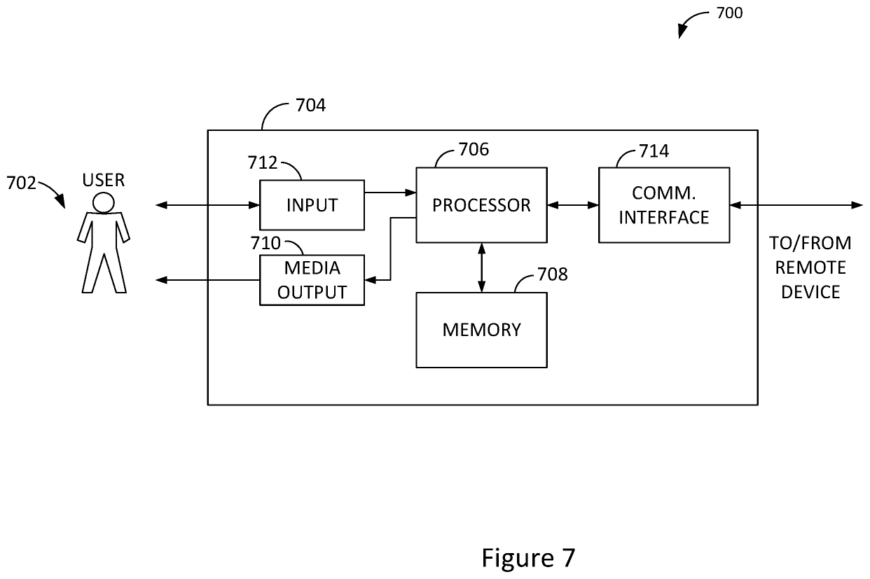

FIG. 7 depicts an exemplary configuration 700 of a user computing device 704 (e.g., user computing device 120, shown in FIGS. 1 and 2), in accordance with one embodiment of the present disclosure. User computing device 704 may be operated by a user 702. User computing device 704 may include, but is not limited to, user computing device 120, insurance provider computer device 122, and admin computer device 118 (all shown in FIG. 1). User computing device 704 may include a processor 706 for executing instructions. In some embodiments, executable instructions may be stored in a memory 708. Processor 706 may include one or more processing units (e.g. in a multi-core configuration). Memory 708 may be any device allowing information such as executable instructions and/or transaction data to be stored and retrieved. Memory 708 may include one or more computer readable media.

User computing device 704 may also include at least one media output component 710 for presenting information to user 702. Media output component 710 may be any component capable of conveying information to user 702. In some embodiments, media output component 710 may include an output adapter (not shown) such as a video adapter and/or an audio adapter. An output adapter may be operatively coupled to processor 706 and operatively coupleable to an output device such as a display device (e.g. a cathode ray tube (CRT), liquid crystal display (LCD), light emitting diode (LED) display, or “electronic ink” display) or an audio output device (e.g. a speaker or headphones).

In some embodiments, media output component 710 may be configured to present a graphical user interface (e.g. a web browser and/or a client application) to user 702. A graphical user interface may include, for example, an online store interface for viewing and/or interacting with inventories, requests, documentation, etc. (shown in FIG. 2). In some embodiments, user computing device 704 may include an input device 712 for receiving input from user 702. User 702 may use input device 712 to, without limitation, update and/or adjust inventories and provide documentation.

Input device 712 may include, for example, a keyboard, a pointing device, a mouse, a stylus, a touch sensitive panel (e.g. a touch pad or a touch screen), a gyroscope, an accelerometer, a position detector, a biometric input device, and/or an audio input device. A single component such as a touch screen may function as both an output device of media output component 710 and input device 712.

User computing device 704 may also include a communication interface 714, communicatively coupled to a remote device such as CRM computing device 102 (shown in FIG. 7). Communication interface 714 may include, for example, a wired or wireless network adapter and/or a wireless data transceiver for use with a mobile telecommunications network.

Stored in memory 708 are, for example, computer readable instructions for providing a user interface to user 702 via media output component 710 and, optionally, receiving and processing input from input device 712. A user interface may include, among other possibilities, a web browser and/or a client application. Web browsers enable users, such as user 702, to display and interact with media and other information typically embedded on a web page or a website from CRM computing device 102. A client application may allow user 702 to interact with, for example, CRM computing device 102. For example, instructions may be stored by a cloud service, and the output of the execution of the instructions sent to the media output component 710.

### Exemplary Server Device

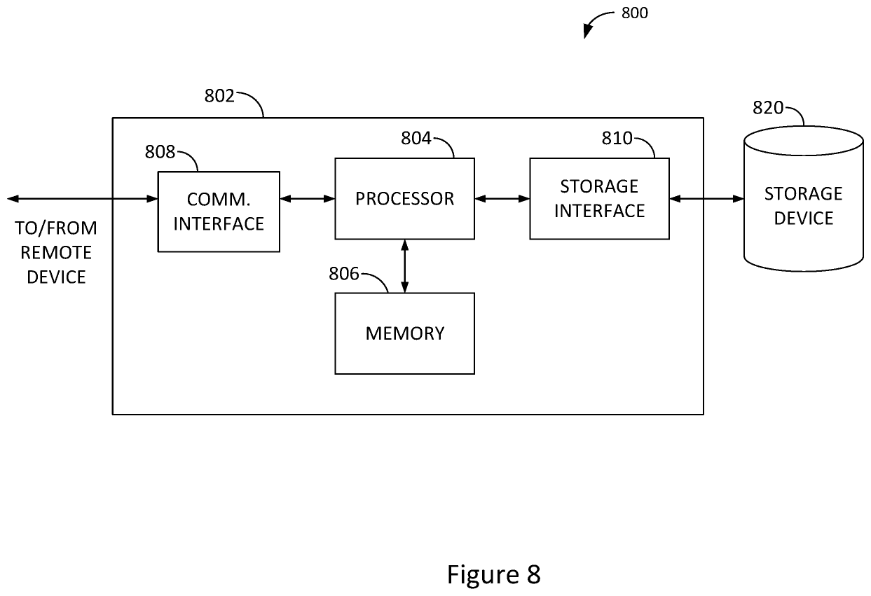

FIG. 8 depicts an exemplary configuration 800 of a server system, in accordance with one embodiment of the present disclosure. Server computing device 802 may include, but is not limited to, CRM computing device 102 (shown in FIG. 1). Server computing device 802 may also include a processor 804 for executing instructions. Instructions may be stored in a memory area 806. Processor 804 may include one or more processing units (e.g. in a multi-core configuration).

Processor 804 may be operatively coupled to a communication interface 808 such that server computing device 802 is capable of communicating with a remote device such as another server computing device 802, CRM computing device 102, insurance provider computing device 122, admin computer device 118, and user computing device 120, third party computer system 114 (including controller 116), and environmental sensors 112 (all shown in FIG. 1).

Processor 804 may also be operatively coupled to a storage device 820. Storage device 820 may be any computer-operated hardware suitable for storing and/or retrieving data, such as, but not limited to, data associated with database 124 (shown in FIG. 1). In some embodiments, storage device 820 may be integrated in server computing device 802. For example, server computing device 802 may include one or more hard disk drives as storage device 820.

In other embodiments, storage device 820 may be external to server computing device 802 and may be accessed by a plurality of server computing devices 802. For example, storage device 820 may include a storage area network (SAN), a network attached storage (NAS) system, and/or multiple storage units such as hard disks and/or solid state disks in a redundant array of inexpensive disks (RAID) configuration.

In some embodiments, processor 804 may be operatively coupled to storage device 820 via a storage interface 810. Storage interface 810 may be any component capable of providing processor 804 with access to storage device 820. Storage interface 810 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 804 with access to storage device 820.

Processor 804 may execute computer-executable instructions for implementing aspects of the disclosure. In some embodiments, the processor 804 may be transformed into a special purpose microprocessor by executing computer-executable instructions or by otherwise being programmed.

### Exemplary Database and Computer Device

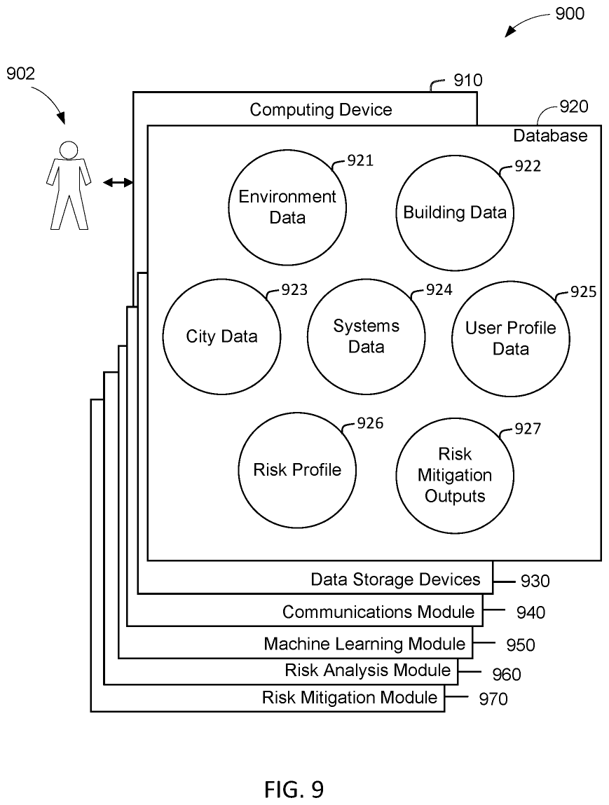

FIG. 9 depicts a diagram 900 of components of one or more exemplary computing devices 910 that may be used in CRM computer system 100 (shown in FIG. 1). In some embodiments, computing device 910 may be similar to CRM computing device 102 (shown in FIG. 1). Database 920 may be coupled with several separate components within computing device 910, which perform specific tasks. In this embodiment, database 920 may include environment data 921, building data 922, city data 923, systems data 924, user profile data 925, risk profile 926, and risk mitigation outputs 927. In alternative embodiments, database 920 may include any of the data discussed in reference to any CRM computer system. In some embodiments, database 920 is similar to database 124 (shown in FIG. 1).

Computing device 910 may include database 920, as well as data storage devices 930, which may include additional local memory. Computing device 910 may also include a communications module 940 (e.g., communications module 104, shown in FIG. 1) that enables communication between computing device 910 and any external computing device and communication between the different components and modules of computing device 910. Computing device 910 may further include machine learning module 950 (e.g., machine learning module 106), which enables computing device 910 to “learn” from historical and real-time data and generate and update trained machine learning modules used for generating risk profiles and risk mitigation outputs.

Moreover, computing device 910 may include risk analysis module 960 (e.g., risk analysis module 108) for analyzing risks and generating risk profiles based upon any of the data described herein. Additionally, computing device 910 may include risk mitigation module 970 (e.g., risk mitigation module 110) for generating risk mitigation outputs, including risk alerts, risk mitigation recommendations, and risk mitigation instructions. Computing device 910 may include additional, less, or alternate functionality, including that discussed elsewhere herein.

### Exemplary Computer-Implemented Methods

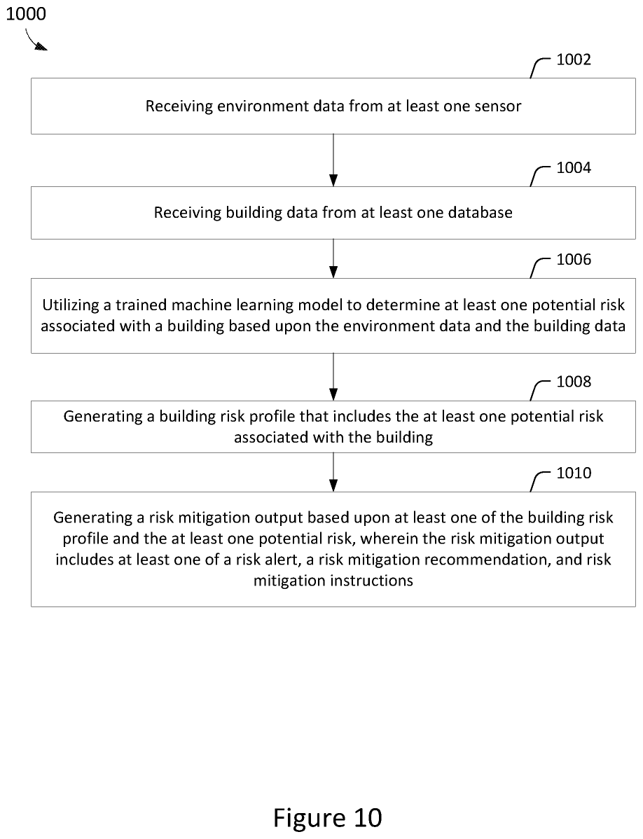

FIG. 10 illustrates a flow chart of an exemplary computer-implemented method 1000 for analyzing and mitigating city-associated risk. Method 1000 may be implemented, for example, by CRM computer system 100 (shown in FIG. 1).

Method 1000 may include receiving 1002 environment data from at least one sensor and receiving 1004 building data from at least one database. Method 1000 may include utilizing 1006 a trained machine learning model to determine at least one potential risk associated with a building based upon the environment data and the building data.

Method 1000 may include generating 1008 a building risk profile that includes the at least one potential risk associated with the building. Method 1000 may also include generating 1010 a risk mitigation output based upon at least one of the building risk profile and the at least one potential risk, wherein the risk mitigation output includes at least one of a risk alert, a risk mitigation recommendation, and risk mitigation instructions. Method 1000 may include additional, less, or alternate actions, including those discussed elsewhere herein.

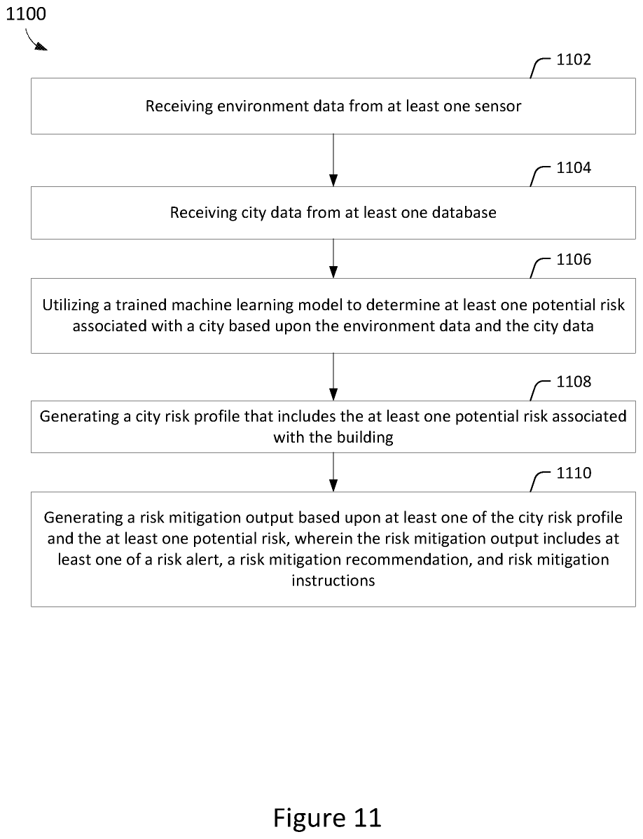

FIG. 11 illustrates a flow chart of an exemplary computer-implemented method 1100 for analyzing and mitigating city-associated risk. Method 1100 may be implemented, for example, by CRM computer system 100.

Method 1100 may include receiving 1102 environment data from at least one sensor and receiving 1104 city data from at least one database. Method 1100 may also include utilizing 1106 a trained machine learning model to determine at least one potential risk associated with a city based upon the environment data and the city data.

Method 1100 may include generating 1108 a city risk profile that includes the at least one potential risk associated with the building. Method 1100 may also include generating 1110 a risk mitigation output based upon at least one of the city risk profile and the at least one potential risk, wherein the risk mitigation output includes at least one of a risk alert, a risk mitigation recommendation, and risk mitigation instructions. Method 1100 may include additional, less, or alternate actions, including those discussed elsewhere herein.

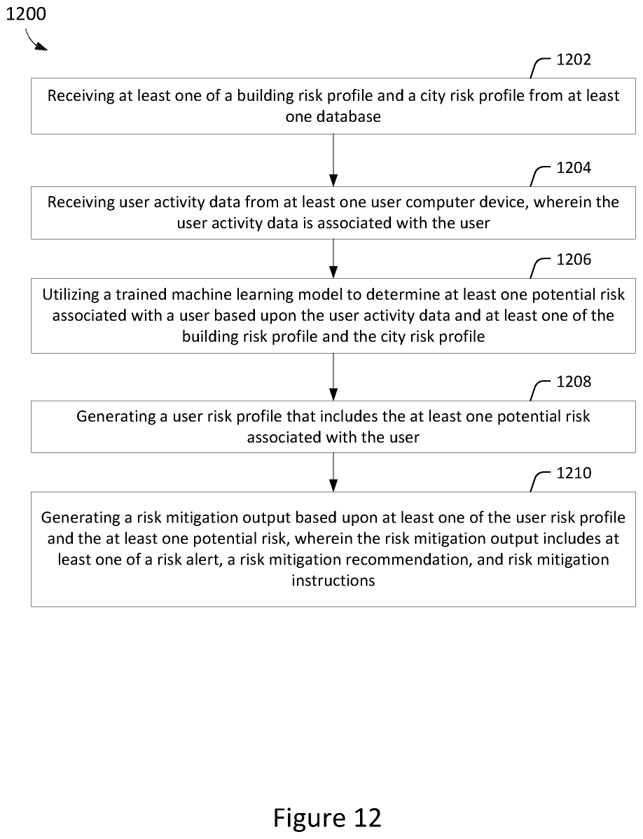

FIG. 12 illustrates a flow chart of an exemplary computer-implemented method 1200 for analyzing and mitigating city-associated risk. Method 1200 may be implemented, for example, by CRM computer system 100.

Method 1200 may include receiving 1202 at least one of a building risk profile and a city risk profile from at least one database and receiving 1204 user activity data from at least one user computer device, wherein the user activity data is associated with the user. Method 1200 may include utilizing 1206 a trained machine learning model to determine at least one potential risk associated with a user based upon the user activity data and at least one of the building risk profile and the city risk profile.

Method 1200 may include generating 1208 a user risk profile that includes the at least one potential risk associated with the user. Method 1200 may also include generating 1210 a risk mitigation output based upon at least one of the city risk profile and the at least one potential risk, wherein the risk mitigation output includes at least one of a risk alert, a risk mitigation recommendation, and risk mitigation instructions. Method 1200 may include additional, less, or alternate actions, including those discussed elsewhere herein.

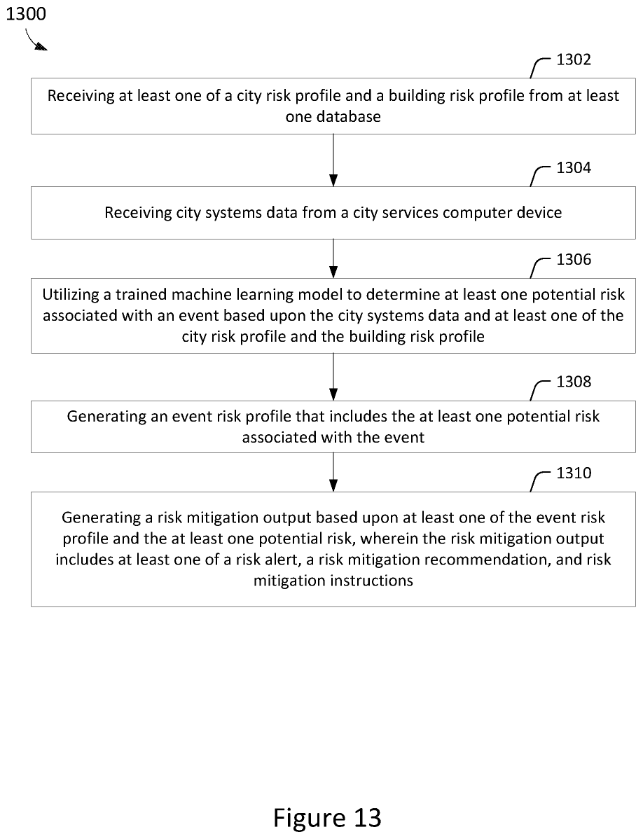

FIG. 13 illustrates a flow chart of an exemplary computer-implemented method 1300 for analyzing and mitigating city-associated risk. Method 1300 may be implemented, for example, by CRM computer system 100.

Method 1300 may include receiving 1302 at least one of a city risk profile and a building risk profile from at least one database and receiving 1304 city systems data from a city services computer device. Method 1300 may also include utilizing 1306 a trained machine learning model to determine at least one potential risk associated with an event based upon the city systems data and at least one of the city risk profile and the building risk profile.

Method 1300 may include generating 1308 an event risk profile that includes the at least one potential risk associated with the event. Method 1300 may also include generating 1310 a risk mitigation output based upon at least one of the event risk profile and the at least one potential risk, wherein the risk mitigation output includes at least one of a risk alert, a risk mitigation recommendation, and risk mitigation instructions. Method 1300 may include additional, less, or alternate actions, including those discussed elsewhere herein.

### Exemplary Embodiments and Functionality

In one exemplary aspect, a computer system for analyzing and mitigating risks associated with a building may be provided. The computer system may include at least one processor and/or associated transceiver in communication with at least one memory device, at least one sensor located proximate to the building, at least one database, and at least one building management computer system including a controller. The at least one processor may be programmed to: (i) receive environment data from the at least one sensor; (ii) receive building data from the at least one database; (iii) utilize a trained machine learning model to determine at least one potential risk associated with the building based upon the environment data and the building data; (iv) generate a building risk profile that includes the at least one potential risk associated with the building; and/or (v) generate a risk mitigation output based upon at least one of the building risk profile and the at least one potential risk, wherein the risk mitigation output includes at least one of a risk alert, a risk mitigation recommendation, and risk mitigation instructions. The computer system may include additional, less, or alternate functionality, including that discussed elsewhere herein.

For instance, in some embodiments, the risk mitigation output is a risk alert and the processor is further configured to transmit the risk alert to at least one of an external computer device and the building management computer system. In a further embodiment, the external computer device is a user computer device and wherein the risk alert causes the user computer device to display a notification.

In some embodiments, the risk mitigation output is a risk mitigation recommendation and the processor is further configured to transmit the risk mitigation instructions to an external computer device. In a further embodiment, the external computer device is a user computer device and wherein the risk mitigation recommendation contains precautionary measures intended for individuals in the building or an area adjacent to the building. In a further embodiment, the external computer device is associated with the building management computer system and wherein the risk mitigation recommendation contains recommended actions for mitigating the at least one potential risk associated with the building.

In some embodiments, the at least one processor is further configured to: (i) receive building systems data from the building management computer system; (ii) utilize a trained machine learning model to determine at least one additional potential risk associated with the building based upon at least the building systems data; (iii) generate an updated building risk profile that includes the at least one additional potential risk associated with the building; and/or (iv) generate a second risk mitigation output based upon at least one of the updated building risk profile and the at least one additional potential risk, wherein the second risk mitigation output includes at least one of a risk alert, a risk mitigation recommendation, and risk mitigation instructions.

In a further embodiment, generating an updated building risk profile includes updating the building risk profile. In a further embodiment, generating an updated building risk profile includes generating a new building risk profile. In a further embodiment, the second risk mitigation output is risk mitigation instructions and the processor is further configured to transmit the risk mitigation instructions to the building management computer system.

In a further embodiment, the risk mitigation instructions are configured to cause the building management computer system to alter operations of a system associated with the building. In a further embodiment, the risk mitigation instructions cause the controller of the building management computer system to alter a physical system associated with the building.

In some embodiments, the environment data includes at least one of internal environment data associated with the environment inside the building and external environment data associated with the environment outside the building.

In some embodiments, generating the building risk profile further comprises associating the potential risk with at least one portion of a three dimensional model of the building. In a further embodiment, generating the building risk profile comprises visually indicating the potential risk in the three dimensional model.

In another exemplary embodiment, computer-implemented method for analyzing and mitigating risks associated with a building may be provided. The method may be implemented by a computer system including at least one processor and/or associated transceiver in communication with at least one memory device, at least one sensor located proximate to the building, and at least one database. The method may include, via one or more processors and/or associated transceivers: (i) receiving environment data from the at least one sensor; (ii) receiving building data from the at least one database; (iii) utilizing a trained machine learning model to determine at least one potential risk associated with the building based upon the environment data and the building data; (iv) generating a building risk profile that includes the at least one potential risk associated with the building; and/or (v) generating a risk mitigation output based upon at least one of the building risk profile and the at least one potential risk, wherein the risk mitigation output includes at least one of a risk alert, a risk mitigation recommendation, and risk mitigation instructions. The method may include additional, less, or alternate actions, including those discussed elsewhere herein.

In another exemplary embodiment, a non-transitory computer-readable storage medium having computer-executable instructions embodied thereon for analyzing and mitigating risks associated with a building is provided. When executed by at least one processor, the computer-executable instructions may cause the processor to (i) receive environment data from the at least one sensor; (ii) receive building data from the at least one database; (iii) utilize a trained machine learning model to determine at least one potential risk associated with the building based upon the environment data and the building data; (iv) generate a building risk profile that includes the at least one potential risk associated with the building; and/or (v) generate a risk mitigation output based upon at least one of the building risk profile and the at least one potential risk, wherein the risk mitigation output includes at least one of a risk alert, a risk mitigation recommendation, and risk mitigation instructions. The computer-executable instructions may direct additional, less, or alternate functionality, including that discussed elsewhere herein.

In one exemplary embodiment, a computer system for analyzing and mitigating risks associated with a city may be provided. The computer system may include at least one processor in communication with at least one memory device, at least one sensor located within the city, at least one database, and at least one city services computer system including a controller. The at least one processor may be programmed to: (i) receive environment data from the at least one sensor; (ii) receive city data from the at least one database; (iii) utilize a trained machine learning model to determine at least one potential risk associated with the city based upon the environment data and the city data; (iv) generate a city risk profile that includes the at least one potential risk associated with the city; and/or (iv) generate a risk mitigation output based upon at least one of the city risk profile and the at least one potential risk associated with the city, wherein the risk mitigation output includes at least one of a risk alert, a risk mitigation recommendation, and risk mitigation instructions. The computer system may include additional, less, or alternate functionality, including that discussed elsewhere herein.

For instance, in some embodiments, the risk mitigation output is a risk alert and the processor is further configured to transmit the risk alert to at least one of an external computer device and the building management computer system. In a further embodiment the external computer device is a user computer device and wherein the risk alert causes the user computer device to display a notification.

In some embodiments the risk mitigation output is a risk mitigation recommendation and the processor is further configured to transmit the risk mitigation instructions to an external computer device. In a further embodiment, the external computer device is a user computer device and wherein the risk mitigation recommendation contains precautionary measures intended for individuals in the city. In a further embodiment the external computer device is associated with a city services computer system in communication with the processor and wherein the risk mitigation recommendation contains recommended actions for mitigating the at least one potential risk associated with the city.

In some embodiments, the at least one processor may be further configured to: (i) receive city systems data from a city services computer system in communication with the processor; (ii) utilize a trained machine learning model to determine at least one additional potential risk associated with the city based upon at least the city systems data; (iii) generate an updated city risk profile that includes the at least one additional potential risk associated with the city; and/or (iv) generate a second risk mitigation output based upon at least one of the updated city risk profile and the at least one additional potential risk, wherein the second risk mitigation output includes at least one of a risk alert, a risk mitigation recommendation, and risk mitigation instructions.

In a further embodiment, generating an updated city risk profile includes updating the city risk profile. In a further embodiment, generating an updated city risk profile includes generating a new city risk profile. In a further embodiment, the second risk mitigation output is risk mitigation instructions and the processor is further configured to transmit the risk mitigation instructions to the city services computer system. In a further embodiment, the risk mitigation instructions are configured to cause the city services computer system to alter operations of a system associated with the city. In a further embodiment, the risk mitigation instructions cause the controller of the city services computer system to alter a physical system associated with the city.

In some embodiments, the at least one processor may be further programmed to: (i) receive a building risk profile including at least one potential risk associated with a building; (ii) utilize a trained machine learning model to determine at least one additional risk associated with the city based upon at least the building risk profile; (iii) generate an updated city risk profile that includes the at least one additional risk associated with the city; and/or (iv) generate an additional risk mitigation output based upon the at least one additional risk associated with the city, wherein the second risk mitigation output includes at least one of a risk alert, a risk mitigation recommendation, and risk mitigation instructions.

In some embodiments, generating the city risk profile comprises associating the potential risk with at least one portion of a three dimensional model of the city. In a further embodiment, generating the city risk profile further comprises visually indicating the potential risk in the three dimensional model.

In some embodiments, identifying the potential risk comprises determining at least one potential outcome associated with the city and determining a risk score for the at least one potential outcome.

In another exemplary embodiment, a computer-implemented method for analyzing and mitigating risks associated with a city may be provided. The method may be implemented by a computer system including at least one processor and associated transceiver in communication with at least one memory device, at least one sensor located within the city, and at least one database. The method may include, via one or more processors and/or associated transceivers: (i) receiving environment data from the at least one sensor; (ii) receiving city data from the at least one database; (iii) utilizing a trained machine learning model to determine at least one potential risk associated with the city based upon the environment data and the city data; (iv) generating a city risk profile that includes the at least one potential risk associated with the city; and/or (iv) generating a risk mitigation output based upon at least one of the city risk profile and the at least one potential risk associated with the city, wherein the risk mitigation output includes at least one of a risk alert, a risk mitigation recommendation, and risk mitigation instructions. The method may include additional, less, or alternate actions, including those discussed elsewhere herein.

In another exemplary embodiment, a non-transitory computer-readable storage medium having computer-executable instructions embodied thereon for analyzing and mitigating risks associated with a city may be provided. When executed by at least one processor, the computer-executable instructions may cause the processor to: (i) receive environment data from the at least one sensor; (ii) receive city data from the at least one database; (iii) utilize a trained machine learning model to determine at least one potential risk associated with the city based upon the environment data and the city data; (iv) generate a city risk profile that includes the at least one potential risk associated with the city; and/or (iv) generate a risk mitigation output based upon at least one of the city risk profile and the at least one potential risk associated with the city, wherein the risk mitigation output includes at least one of a risk alert, a risk mitigation recommendation, and risk mitigation instructions. The computer-executable instructions may direct additional, less, or alternate functionality, including that discussed elsewhere herein.

In one exemplary embodiment, a computer system for analyzing and mitigating risks associated with a user may be provided. The computer system includes at least one processor and/or transceiver in communication with at least one memory device, at least one database, and at least one user computer device. The at least one processor may be programmed to: (i) receive at least one of a building risk profile and a city risk profile from the at least one database; (ii) receive user activity data from the at least one user computer device, wherein the user activity data is associated with the user; (iii) utilize a trained machine learning model to determine at least one potential risk associated with the user based upon the user activity data and at least one of the building risk profile and the city risk profile; (iv) generate a user risk profile that includes the at least one potential risk associated with the user; and/or (v) generate a risk mitigation output based upon at least one of the user risk profile and the at least one potential risk, wherein the risk mitigation output includes at least one of a risk alert, a risk mitigation recommendation, and risk mitigation instructions. The computer system may include additional, less, or alternate functionality, including that discussed elsewhere herein.

For instance, in some embodiments, the risk mitigation output is a risk alert and the processor is further configured to transmit the risk alert to at least one of an external computer device and the building management computer system. In a further embodiment, wherein the external computer device is a user computer device and wherein the risk alert causes the user computer device to display a notification to a user.

In some embodiments, the risk mitigation output is a risk mitigation recommendation and the processor is further configured to transmit the risk mitigation instructions to an external computer device. In a further embodiment, the external computer device is a user computer device and wherein the risk mitigation recommendation contains precautionary measures intended for user. In a further embodiment, the external computer device is an insurance provider computer device, and wherein the risk mitigation recommendation contains a recommended action for updating an insurance policy associated with the user based on the potential risk.

In some embodiments, the risk mitigation output is risk mitigation instructions and the processor is further configured to transmit the risk mitigation instructions to an external computer device. In a further embodiment, the external computer device is the user computer device, and wherein the risk mitigation instructions are configured to cause the user computer device to alter its operations. In a further embodiment, the external computer device is an insurance provider computer device associated with an insurance provider, and wherein the risk mitigation instructions are configured to cause the insurance provider device to alter an insurance policy associated with the user based on the potential risk.

In some embodiments, the at least one processor may be further configured to: (i) receive user profile data from a database; (ii) utilize a trained machine learning model to determine at least one additional potential risk associated with the user based upon at least the user profile data; (iii) generate an updated user risk profile that includes the at least one additional potential risk associated with the user; and/or (iv) generate a second risk mitigation output based upon at least one of the updated user risk profile and the at least one additional potential risk, wherein the second risk mitigation output includes at least one of a risk alert, a risk mitigation recommendation, and risk mitigation instructions.

In some embodiments, identifying the potential risk comprises determining at least one potential outcome associated with the city and determining a risk score for the at least one potential outcome.

In another exemplary embodiment, a computer-implemented method for analyzing and mitigating risks associated with a city may be provided. The method may be implemented by a computer system including at least one processor and/or transceiver in communication with at least one memory device, at least one database, and at least one user computer device. The method may include, via one or more processors and/or associated transceivers: (i) receiving at least one of a building risk profile and a city risk profile from the at least one database; (ii) receiving user activity data from the at least one user computer device, wherein the user activity data is associated with the user; (iii) utilizing a trained machine learning model to determine at least one potential risk associated with the user based upon the user activity data and at least one of the building risk profile and the city risk profile; (iv) generating a user risk profile that includes the at least one potential risk associated with the user; and/or (v) generating a risk mitigation output based upon at least one of the user risk profile and the at least one potential risk, wherein the risk mitigation output includes at least one of a risk alert, a risk mitigation recommendation, and risk mitigation instructions. The method may include additional, less, or alternate actions, including those discussed elsewhere herein.

In another exemplary embodiment, a non-transitory computer-readable storage medium having computer-executable instructions embodied thereon for analyzing and mitigating risks associated with a building may be provided. When executed by at least one processor, the computer-executable instructions may cause the processor to: (i) receive at least one of a building risk profile and a city risk profile from the at least one database; (ii) receive user activity data from the at least one user computer device, wherein the user activity data is associated with the user; (iii) utilize a trained machine learning model to determine at least one potential risk associated with the user based upon the user activity data and at least one of the building risk profile and the city risk profile; (iv) generate a user risk profile that includes the at least one potential risk associated with the user; and/or (v) generate a risk mitigation output based upon at least one of the user risk profile and the at least one potential risk, wherein the risk mitigation output includes at least one of a risk alert, a risk mitigation recommendation, and risk mitigation instructions. The computer-executable instructions may direct additional, less, or alternate functionality, including that discussed elsewhere herein.

In one exemplary embodiment, a computer system for analyzing and mitigating risks associated with an event may be provided. The computer system includes at least one processor and/or transceiver in communication with at least one memory device, at least one sensor, at least one third party computer device, at least one city services computer system including a controller, and at least one database. The at least one processor and/or transceiver may be programmed to: (i) receive at least one of a city risk profile and a building risk profile from the at least one database; (ii) receive city systems data from the city services computer device; (iii) utilize a trained machine learning model to determine at least one potential risk associated with the event based upon the city systems data and at least one of the city risk profile and the building risk profile; (iv) generate an event risk profile that includes the at least one potential risk associated with the event; and/or (v) generate a risk mitigation output based upon at least one of the event risk profile and the at least one potential risk, wherein the risk mitigation output includes at least one of a risk alert, a risk mitigation recommendation, and risk mitigation instructions. The computer system may include additional, less, or alternate functionality, including that discussed elsewhere herein.

For instance, in some embodiments, the risk mitigation output is a risk alert and the processor is further configured to transmit the risk alert to at least one of an external computer device and the building management computer system. In a further embodiment, the external computer device is a user computer device, and wherein the risk alert causes the user computer device to display a notification. In a further embodiment, the external computer device is the city services computer system.

In some embodiments, the risk mitigation output is a risk mitigation recommendation and the processor is further configured to transmit the risk mitigation instructions to an external computer device. In a further embodiment, the external computer device is a user computer device and wherein the risk mitigation recommendation contains precautionary measures intended for individuals within a certain distance of an area affected by the event. In a further embodiment, the external computer device is associated with the city services computer system and wherein the risk mitigation recommendation contains recommended actions for mitigating the at least one potential risk associated with the event.

In some embodiments, the risk mitigation output is risk mitigation instructions and the processor is further configured to transmit the risk mitigation instructions to an external computer device. In a further embodiment, the external computer device is a user computer device, and wherein the risk mitigation instructions are configured to cause the user computer device to alter its operations. In a further embodiment, the external computer device is the city services computer system, and wherein the risk mitigation instructions are configured to cause the city services computer system to alter operations of a computer system associated with the city. In a further embodiment, the external computer device is the city services computer system, and wherein the risk mitigation instructions cause the controller of the city services computer system to alter a physical system associated with the city.

In some embodiments, the at least one processor is further configured to: (i) receive event data from a third party computer system, wherein the event data is associated with the event; (ii) utilize a trained machine learning model to determine at least one additional potential risk associated with the event based upon at least the event data; (iii) generate an updated event risk profile that includes the at least one additional potential risk associated with the event; and/or (iv) generate a second risk mitigation output based upon at least one of the updated event risk profile and the at least one additional potential risk, wherein the second risk mitigation output includes at least one of a risk alert, a risk mitigation recommendation, and risk mitigation instructions.

In some embodiments, the at least one processor may be further configured to: (i) receive sensor data from the at least one sensor; (ii) utilize a trained machine learning model to determine at least one additional potential risk associated with the event based upon at least the sensor data; (iii) generate an updated event risk profile that includes the at least one additional potential risk associated with the event; and/or (iv) generate a second risk mitigation output based upon at least one of the updated event risk profile and the at least one additional potential risk, wherein the second risk mitigation output includes at least one of a risk alert, a risk mitigation recommendation, and risk mitigation instructions.

In some embodiments, identifying the potential risk comprises determining at least one potential outcome associated with the city and determining a risk score for the at least one potential outcome.

In another aspect, a computer-implemented method for analyzing and mitigating risks associated with an event may be provided. The method may be implemented by a computer system including at least one processor and/or transceiver in communication with at least one memory device, at least one city services computer system including a controller, and at least one database. The method includes, via one or more processors and/or transceivers: (i) receiving at least one of a city risk profile and a building risk profile from the at least one database; (ii) receiving city systems data from the city services computer device; (iii) utilizing a trained machine learning model to determine at least one potential risk associated with the event based upon the city systems data and at least one of the city risk profile and the building risk profile; (iv) generating an event risk profile that includes the at least one potential risk associated with the event; and/or (v) generating a risk mitigation output based upon at least one of the event risk profile and the at least one potential risk, wherein the risk mitigation output includes at least one of a risk alert, a risk mitigation recommendation, and risk mitigation instructions. The method may include additional, less, or alternate actions, including those discussed elsewhere herein.

In another aspect, a non-transitory computer-readable storage medium having computer-executable instructions embodied thereon for analyzing and mitigating risks associated with an event may be provided. When executed by at least one processor, the computer-executable instructions may cause the processor to: (i) receive at least one of a city risk profile and a building risk profile from the at least one database; (ii) receive city systems data from the city services computer device; (iii) utilize a trained machine learning model to determine at least one potential risk associated with the event based upon the city systems data and at least one of the city risk profile and the building risk profile; (iv) generate an event risk profile that includes the at least one potential risk associated with the event; and/or (v) generate a risk mitigation output based upon at least one of the event risk profile and the at least one potential risk, wherein the risk mitigation output includes at least one of a risk alert, a risk mitigation recommendation, and risk mitigation instructions. The computer-executable instructions may direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, driver and/or vehicle, documents to be provided, the model being simulated, home owner and/or home, buyer, geolocation information, image data, home sensor data, and/or other data.

Based upon these analyses, the processing element may learn how to identify characteristics and patterns that may then be applied to training models, analyzing sensor data, authentication data, image data, mobile device data, and/or other data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment,” “exemplary embodiment,” or “one embodiment” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system for analyzing and mitigating risks associated with an event, the computer system comprising at least one processor and at least one memory device, the at least one processor programmed to:
train a machine learning model by defining function coefficients for the machine learning model based upon training data comprising historical city systems data comprising a layout of city security systems in a city and historical scheduled event data comprising historical scheduled events in the city and one or more risks associated with the historical scheduled events, wherein the function coefficients are defined by at least one of supervised machine learning, unsupervised machine learning, or reinforcement machine learning, thereby generating a trained machine learning model configured to identify risks and risk locations within the city;
receive new city systems data from at least one city services computer system, the new city systems data identifying a location of a scheduled event and a time that the scheduled event is scheduled to occur within the city;
utilize the trained machine learning model to determine at least one potential risk associated with the scheduled event;
identify at least one individual potentially impacted by the at least one potential risk based at least in part upon the location of the scheduled event and at least one individual profile associated with the at least one individual indicating that at least one scheduled or predicted commute of the at least one individual includes travel proximate to the location;
update at least one user profile associated with the at least one individual to be associated with a first risk level based on the at least one individual being potentially impacted by the at least one potential risk;
transmit content associated with the at least one potential risk to a computing system associated with the at least one individual, wherein the content is configured to cause initiation of at least one risk mitigating action proximate to the time that the scheduled event is scheduled to occur, and wherein the at least one risk mitigating action is associated with risk reduction for the at least one individual with respect to the scheduled event;
determine that the at least one risk mitigating action was performed proximate to the time the scheduled event was scheduled to occur; and
update the at least one user profile to be associated with a second risk level based on the at least one risk mitigating action being performed proximate to the time the scheduled event was scheduled to occur, wherein the second risk level is lower than the first risk level.

2. The computer system of claim 1, wherein the content includes a risk alert and the computing system is an external computer device.

3. The computer system of claim 2, wherein the external computer device is a user computer device, and wherein the risk alert causes the user computer device to display a notification.

4. The computer system of claim 2, wherein the external computer device is the at least one city services computer system.

5. The computer system of claim 1, wherein the content includes a risk mitigation recommendation and the at least one processor is further configured to transmit risk mitigation instructions to an external computer device.

6. The computer system of claim 5, wherein the external computer device is a user computer device and wherein the risk mitigation recommendation contains precautionary measures intended for individuals within a certain distance of an area affected by the event.

7. The computer system of claim 5, wherein the external computer device is associated with the at least one city services computer system and wherein the risk mitigation recommendation contains recommended actions for mitigating the at least one potential risk associated with the event.

8. The computer system of claim 1, wherein the content includes risk mitigation instructions and the at least one processor is further configured to transmit the risk mitigation instructions to the computing system, wherein the computing system comprises an external computer device.

9. The computer system of claim 8, wherein the external computer device is a user computer device, and wherein the risk mitigation instructions are configured to cause the user computer device to alter its operations.

10. The computer system of claim 8, wherein the external computer device is the at least one city services computer system, and wherein the risk mitigation instructions are configured to cause the at least one city services computer system to implement the at least one mitigating action.

11. The computer system of claim 8, wherein the external computer device is the at least one city services computer system, and wherein the risk mitigation instructions cause the at least one city services computer system to alter a physical system associated with the city.

12. The computer system of claim 1, wherein the at least one processor is further configured to:
receive event data from a third party computer system, wherein the event data is associated with the event;
utilize the trained machine learning model to determine at least one additional potential risk associated with the event based upon at least the event data;
generate an updated event risk profile that includes the at least one additional potential risk associated with the event; and
generate a second risk mitigation output based upon at least one of the updated event risk profile or the at least one additional potential risk, wherein the second risk mitigation output includes at least one of a second risk alert, a second risk mitigation recommendation, or second risk mitigation instructions.

13. The computer system of claim 1, wherein the at least one processor is further configured to:
receive sensor data from at least one sensor;
utilize the trained machine learning model to determine at least one additional potential risk associated with the event based upon at least the sensor data;
generate an updated event risk profile that includes the at least one additional potential risk associated with the event; and
generate a second risk mitigation output based upon at least one of the updated event risk profile or the at least one additional potential risk, wherein the second risk mitigation output includes at least one of a second risk alert, a second risk mitigation recommendation, or second risk mitigation instructions.

14. (canceled)

15. A computer-implemented method for analyzing and mitigating risks associated with an event, the method implemented by a computer system comprising at least one processor and at least one memory device, the computer-implemented method comprising:
training a machine learning model by defining function coefficients for the machine learning model based upon training data comprising historical city systems data comprising a layout of city security systems in a city and historical scheduled event data comprising historical scheduled events in the city and one or more risks associated with the historical scheduled events, wherein the function coefficients are defined by at least one of supervised machine learning, unsupervised machine learning, or reinforcement machine learning, thereby generating a trained machine learning model configured to identify risks and risk locations within the city;
receiving new city systems data from a city services computer system, the new city systems data identifying a location of a scheduled event and a time that the scheduled event is scheduled to occur within the city;
utilizing the trained machine learning model to determine at least one potential risk associated with the scheduled event;
identifying at least one individual potentially impacted by the at least one potential risk based at least in part upon the location of the scheduled event and at least one individual profile associated with the at least one individual indicating that at least one scheduled or predicted commute of the at least one individual includes travel proximate to the location;
updating at least one user profile associated with the at least one individual to be associated with a first risk level based on the at least one individual being potentially impacted by the at least one potential risk;
transmitting content associated with the at least one potential risk to a computing system associated with the at least one individual, wherein the content is configured to cause initiation of at least one risk mitigating action proximate to the time that the scheduled event is scheduled to occur, and wherein the at least one risk mitigating action is associated with risk reduction for the at least one individual with respect to the scheduled event;
determining that the at least one risk mitigating action was performed proximate to the time the scheduled event was scheduled to occur; and
updating the at least one user profile to be associated with a second risk level based on the at least one risk mitigating action being performed proximate to the time the scheduled event was scheduled to occur, wherein the second risk level is lower than the first risk level.

16. A non-transitory computer-readable storage medium comprising computer-executable instructions embodied thereon for analyzing and mitigating risks associated with an event, wherein when executed by at least one processor, the computer-executable instructions cause the at least one processor to:
train a machine learning model by defining function coefficients for the machine learning model based upon training data comprising historical city systems data comprising a layout of city security systems in a city and historical scheduled event data comprising historical scheduled events in the city and one or more risks associated with the historical scheduled events, wherein the function coefficients are defined by at least one of supervised machine learning, unsupervised machine learning, or reinforcement machine learning, thereby generating a trained machine learning model configured to identify risks and risk locations within the city;
receive new city systems data from at least one city services computer system, the new city systems data identifying a location of a scheduled event and a time that the scheduled event is scheduled to occur within the city;
utilize the trained machine learning model to determine at least one potential risk associated with the scheduled event;
identify at least one individual potentially impacted by the at least one potential risk based at least in part upon the location of the scheduled event and at least one individual profile associated with the at least one individual indicating that at least one scheduled or predicted commute of the at least one individual includes travel proximate to the location;
update at least one user profile associated with the at least one individual to be associated with a first risk level based on the at least one individual being potentially impacted by the at least one potential risk;
transmit content associated with the at least one potential risk to a computing system associated with the at least one individual, wherein the content is configured to cause initiation of at least one risk mitigating action proximate to the time that the scheduled event is scheduled to occur, and wherein the at least one risk mitigating action is associated with risk reduction for the at least one individual with respect to the scheduled event;
determine that the at least one risk mitigating action was performed proximate to the time the scheduled event was scheduled to occur; and
update the at least one user profile to be associated with a second risk level based on the at least one risk mitigating action being performed proximate to the time the scheduled event was scheduled to occur, wherein the second risk level is lower than the first risk level.

17. (canceled)

18. (canceled)

19. The computer system of claim 1, wherein the computer system comprises a user computing device, and wherein the at least one risk mitigating action comprises causing the user computing device to display an alternate transportation route determined to be safer than a current transportation route.

20. (canceled)

21. (canceled)

22. The computer system of claim 1, wherein the computer system comprises a building computer system, and wherein the building computer system is configured to cause initiation of the at least one risk mitigating action by activating at least one security measure at at least one building associated with the building computer system.

23. The computer system of claim 1, wherein the computing system comprises the at least one city services computer system, and wherein the at least one city services computer system is configured to cause initiation of the at least one risk mitigating action by at least one of halting operation, rebooting, activating or deactivating, or altering operation of a system associated with the location.

24. The computer system of claim 1, wherein the scheduled event is one of a concert, a festival, or a parade.

25. The computer system of claim 1, wherein the at least one processor is further programmed to transmit the content to the computing system proximate to the event being scheduled.
